(19) United States
(12) Patent Application Publication
(10) Pub. No.: US 2013/0332233 A1
(43) Pub. Date: Dec. 12, 2013

(54) PREDICTION SYSTEM AND PROGRAM FOR PARTS SHIPMENT QUANTITY

(71) Applicants: Naoko Kishikawa, Tokyo (JP); Jun Tateishi, Tokyo (JP); Kenji Tamaki, Tokyo (JP)

(72) Inventors: Naoko Kishikawa, Tokyo (JP); Jun Tateishi, Tokyo (JP); Kenji Tamaki, Tokyo (JP)

(21) Appl. No.: 13/981,094

(22) PCT Filed: Feb. 23, 2011
(86) PCT No.: PCT/JP2011/054021

§ 371 Date: Aug. 26, 2013

(51) Int. Cl. G06Q 30/02

(52) U.S. Cl. CPC G06Q 30/0202
USPC 705/7.31

(57) ABSTRACT

There is provided a system or others capable of predicting a parts shipment quantity varying in accordance with an assumed parts-purchase period (such as a charge-free warranty period of a product) (having a period length with taking a product shipping date as a starting point during which a customer is assumed to purchase parts) so that prediction accuracy can be increased more than a conventional one. In the prediction system (1) for the parts shipment quantity, a server (10) has a prediction unit (100) to which product data (D1), parts shipment data (D2), and a prediction condition (D3) containing information of the assumed parts-purchase period are inputted and which performs a process of predicting a future shipment quantity for each parts and of outputting prediction result data (D0). The prediction unit (100) performs a process of predicting the future shipment quantity for each parts in accordance with the assumed parts-purchase period.

### TECHNICAL FIELD

The present invention relates to a technique of an information processing system and others, and, more particularly, the present invention relates to a system performing a prediction process for parts shipment quantity and others.

### BACKGROUND ART

As examples of prior art of the present technical field, Japanese Patent Application Laid-Open Publication No. 2003-263300 (Patent Document 1), Japanese Patent Application Laid-Open Publication No. 2003-141329 (Patent Document 2), and others are cited.

Patent Document 1 describes that “conventionally, regarding a product such as a copy machine and a printer accompanied with consumable parts, . . . a demand quantity of the consumable parts is experimentally determined from transition of actual past sales of the consumable parts, market trend, and a planned sales quantity of the product main body” and that “a consumption quantity of the consumable parts required for outputting future outputs, is predicted from the output quantity of outputs to be outputted from the product and the sales quantity of the consumable parts” (see Abstract).

Patent Document 2 describes “a device for calculating the demand quantity of non genuine parts by taking an estimated quantity D as the nationwide demand quantity of the non genuine part, the device including: P counting means 12 for counting a quantity P of a product sold to a specific consumer purchasing the product and only its genuine part; Q counting means 13 for counting a quantity Q of the genuine part sold to the specific consumer; A counting means 14 for counting a quantity A of the nationwide-owned product; B counting means 15 for counting a quantity B of the genuine part sold nationwide; . . . C calculating means 16 for calculating an estimated quantity C of the part of the product sold nationwide from “C=A·(Q/P)” by using the counting results P, Q, and A, . . . and D calculating means 17 for calculating the estimated quantity D of the non genuine part of the product sold nationwide from “D=C−B” by using the counting result B” (see Abstract).

As a background, for information management of a product and its parts and others, it is effective to predict parts shipment quantity. For example, it is effective to order the parts based on the predicted parts shipment quantity.

### PRIOR ART DOCUMENTS

### Patent Documents

Patent Document 1: Japanese Patent Application Laid-Open Publication No. 2003-263300

Patent Document 2: Japanese Patent Application Laid-Open Publication No. 2003-141329

### DISCLOSURE OF THE INVENTION

### Problems to be Solved by the Invention

A problem is to predict shipment quantity of manufacturer's genuine parts varying in accordance with an assumed parts-purchase period (such as a charge-free warranty period of the product, a sales-promotion enhanced period thereof, and a product trade-in campaign start timing thereof) which has a period length during which a customer is assumed to purchase the parts with taking a product shipping date as a starting point.

First, the charge-free warranty period of the product is a period with taking the product shipping date as the starting point, during which charge-free maintenance by a manufacturer in failure of the product is warranted under a condition that the customer definitely uses a manufacturer's genuine parts as consumable parts or replacement parts for which periodic replacement is recommended. Generally, there is a tendency such that, while the customer actively purchases the manufacturer's genuine parts during the charge-free warranty period of the product in order to be warranted, the customer purchases the non genuine parts which is cheaper after the end of the warranty period in order to reduce a purchase price of the maintenance parts.

Next, the sales-promotion enhanced period is a period with taking the product shipping date as the starting point, during which the manufacturer actively performs sales promotion (such as visiting the customer and sending a direct mail) so as to encourage the customer to purchase the manufacturer's genuine parts. Generally, during the sales-promotion enhanced period, it is easy to purchase the manufacturer's genuine parts (such that the parts can be purchased when a manufacturer's sales representative visits the customer), and therefore, there is a tendency to increase the purchase of the manufacturer's genuine parts. After the sales-promotion enhanced period, it is comparatively not easy to purchase the parts, and therefore, there is a tendency to increase the purchase of the non genuine parts.

Also, the product trade-in campaign start timing is a timing of campaign start with taking the product shipping date as the starting point, at which an old product already owned by the customer is traded in by the manufacturer under a condition that the customer purchases a new product. Generally, there is a tendency such that, while the customer purchases the parts (genuine parts) for the old product before the start of the campaign, the customer plans the purchase of the new product for the replacement after the start of the campaign, and therefore, stops the purchase of the parts for the old product.

Accordingly, generally, the assumed parts-purchase period is longer as the charge-free warranty period and the sales-promotion enhanced period of the product are longer, and besides, as the product trade-in campaign start timing is later. Also, a customer who owns a product having cumulative elapsed time from the product shipping date within the assumed parts-purchase period generally actively purchases the manufacturer's genuine parts, and therefore, the shipment quantity of the manufacturer's genuine parts is generally proportional to the operating product quantity having the cumulative elapsed time within the assumed parts-purchase period from the product shipping date. From the above description, it is considered that prediction accuracy of the shipment quantity of the manufacturer's genuine parts can be improved more than that of a conventional technique by estimating the assumed parts-purchase period in accordance with the charge-free warranty period of the product, the sales-promotion enhanced period thereof, and the product trade-in campaign start timing thereof, predicting the operating product quantity within the estimated assumed parts-purchase period, and predicting the shipment quantity of the manufacturer's genuine parts in accordance with the predicted operating product quantity.

The exemplified prior arts (Patent Documents 1 and 2) neither disclose nor suggest a prediction process for the parts shipment quantity in consideration of the assumed parts-purchase period (such as the charge-free warranty period of the product, the sales-promotion enhanced period thereof, and the product trade-in campaign start timing thereof).

Patent Document 1 describes that the prediction model for the parts shipment quantity is changed when it is determined that purchase of the genuine parts by a user has decreased whereas purchase of imitation parts (the non genuine parts) has increased. However, there is no specific description for this method.

Patent Document 2 describes a method of estimating respective market shares of the genuine parts and imitation parts (the non genuine parts). However, there is no description of a method of utilization for prediction of the parts shipment quantity, and therefore, the assumed parts-purchase period is not utilized.

In consideration of the above description, a main preferred aim of the present invention is to provide a technique such as a system capable of predicting the parts shipment quantity varying in accordance with the assumed parts-purchase period (such as the charge-free warranty period of the product) so as to increase the prediction accuracy more than a conventional one.

In the present specification, note that the “product” includes not only the copy machine and the printer but also, for example, construction machine (such as a digger truck and a dump truck), medical equipment (such as a magnetic resonance imaging device: MRI), infrastructure equipment (such as equipment an electric power plant facility, a water purification facility, and others), etc. For example, the product also includes a turbine of the electric power plant, an electric generator thereof, etc. The “parts” include not only parts to be a component of the product (such as a basic parts such as an engine, a structural parts such as a bolt, and an electronic parts) but also consumable parts and periodic replacement parts associated with the operation, the maintenance, and others of the product (such as a filter and oil). For example, when the product is the construction machine, a filter, oil, a battery, a bucket hook, underbody parts, an oil pressure pump, an engine, and others are cited as the parts associated with the operation, the maintenance, and others. When the product is the MRI, a cable, a print board, a coil, and others are cited as the parts. When the product is the electric generator, a turbine blade, a combustor, rotation parts, and others are cited as the parts. When the product is the water purification facility, a filter, a pump, a valve, a pipe, and others are cited as the parts.

### Means for Solving the Problems

A typical aspect of the present invention is an information processing system (a prediction system for the parts shipment quantity), a program, and others performing a prediction process for the parts shipment quantity, and has a feature of the following structure.

The present system includes a function (a prediction unit) of performing the prediction process for the parts shipment quantity in accordance with the assumed parts-purchase period. In the present system, the assumed parts-purchase period is defined, and is utilized for the prediction of the parts shipment quantity (the prediction process is performed based on a prediction condition including the assumed parts-purchase period). As factors determining the assumed parts-purchase period, a warranty period (a charge-free warranty period of the product), a sales-promotion period, a campaign period, and others are cited. Also, the present system provides a user interface for allowing a user (such as an administrator) to set the assumed parts-purchase period. For example, on a screen, a value of the assumed parts-purchase period or a value of the factor (parameter) can be set. Since more or less (increase or decrease of) the variation in the parts shipment quantity can be estimated in accordance with the long or short assumed parts-purchase period, the present system (the prediction unit) performs the prediction process for the parts shipment quantity in accordance with the prediction condition including the assumed parts-purchase period.

The prediction system for the parts shipment quantity has: an input processing unit which performs a process of inputting product data, parts shipment data, and the prediction condition into a computer; a storage unit which stores the product data, the parts shipment data, and the prediction condition; a prediction unit to which the product data, the parts shipment data, and the prediction condition are inputted, which performs a process of predicting a future shipment quantity for each parts; and which outputs prediction result data; and an output processing unit which performs a process of storing or outputting the prediction result data. The product data contains date information of actual shipment and removal for each product. The parts shipment data contains date information and quantity information of the actual shipment for each parts. The prediction condition contains information of the assumed parts-purchase period. The prediction unit performs the process of predicting the future shipment quantity for each parts in accordance with the assumed parts-purchase period.

### Effects of the Invention

According to the typical aspect of the present invention, the parts shipment quantity varying in accordance with the assumed parts-purchase period (such as the charge-free warranty period of the product, the sales-promotion enhanced period thereof, and the product trade-in campaign start timing thereof) can be predicted, so that the prediction accuracy can be increased more than a conventional one.

Also, more particularly, the invention has an effect that, even when change of the charge-free warranty period or others is considered in parts business, it can be estimated to what extent the parts shipment quantity is affected by variation in the assumed parts-purchase period due to the change.

### BRIEF DESCRIPTIONS OF THE DRAWINGS

FIG. 1 is a diagram illustrating a system overview including a prediction system for the parts shipment quantity and its related elements according to a first embodiment of the present invention;

FIG. 2 is a diagram illustrating a structure example of the prediction system for the parts shipment quantity of the first embodiment;

FIG. 3 is a diagram illustrating a flow of a prediction process of the first embodiment;

FIG. 4 is a diagram illustrating a table example of product data (D1) of the first embodiment;

FIG. 5 is a diagram illustrating a table example of parts shipment data (D2) of the first embodiment;

FIG. 6 is a diagram illustrating a table example of prediction result data (D0) of the first embodiment;

FIGS. 7A and 7B are diagrams illustrating examples of an input screen of the first embodiment;

FIG. 8 is a diagram illustrating an example of an output screen of the first embodiment;

FIG. 9 is a diagram illustrating an example of a first process flow of the prediction process at a step of S4 of FIG. 3;

FIG. 10 is a diagram illustrating a prediction model for the parts shipment quantity in the first process flow of the first embodiment;

FIG. 11 is a diagram illustrating an example of a second process flow of the prediction process in the first embodiment;

FIGS. 12A and 12B are diagrams illustrating a prediction model for the parts shipment quantity in the second process flow of the first embodiment;

FIGS. 13A and 13B are diagrams illustrating a practical example using actual data regarding the second process flow of the first embodiment;

FIG. 14 is a diagram illustrating a structure example of a prediction system for the parts shipment quantity of a second embodiment;

FIG. 15 is a diagram illustrating a process flow of a system of the second embodiment;

FIG. 16 is a diagram illustrating a structure example of a prediction system for the parts shipment quantity of a third embodiment;

FIG. 17 is a diagram illustrating a process flow of a system of the third embodiment;

FIG. 18 is a diagram illustrating a table example of prediction result data (D7) of the third embodiment;

FIG. 19 is a diagram illustrating an example of an output screen of the third embodiment;

FIG. 20 is a diagram illustrating a structure example of systems of fourth, fifth, and sixth embodiments (a prediction system or an optimization system for the parts shipment quantity);

FIG. 21 is a diagram illustrating a table example of warranty-target flag data (D11) of the fourth embodiment;

FIG. 22 is a diagram illustrating an example of an output screen of the fourth embodiment; and

FIG. 23 is a diagram illustrating a table example of data of actual stock quantity at all warehouses and distributors of the sixth embodiment.

### BEST MODE FOR CARRYING OUT THE INVENTION

Hereinafter, embodiments of the present invention will be described in detail based on the drawings. Note that the same components are denoted by the same reference symbols in principle throughout all drawings for describing the embodiments, and the repetitive description thereof will be omitted. As the reference symbol on the explanation, for example, the assumed parts-purchase period is denoted by “H”.

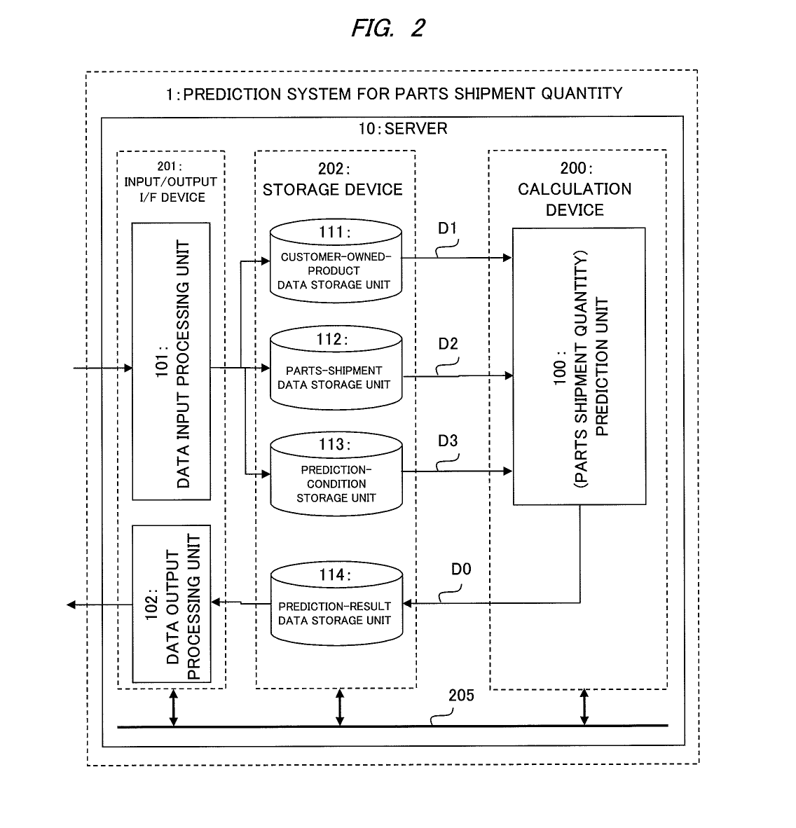

A main feature of the system (the prediction system for the parts shipment quantity) of the present embodiment is that the system has a processing function of performing the prediction process for the parts shipment quantity by utilizing the assumed parts-purchase period H (including the charge-free warranty period). The processing function is mainly achieved by a prediction unit 100 of FIG. 2. Also, the prediction condition (D3) of FIG. 2 contains information of the assumed parts-purchase period H.

### First Embodiment

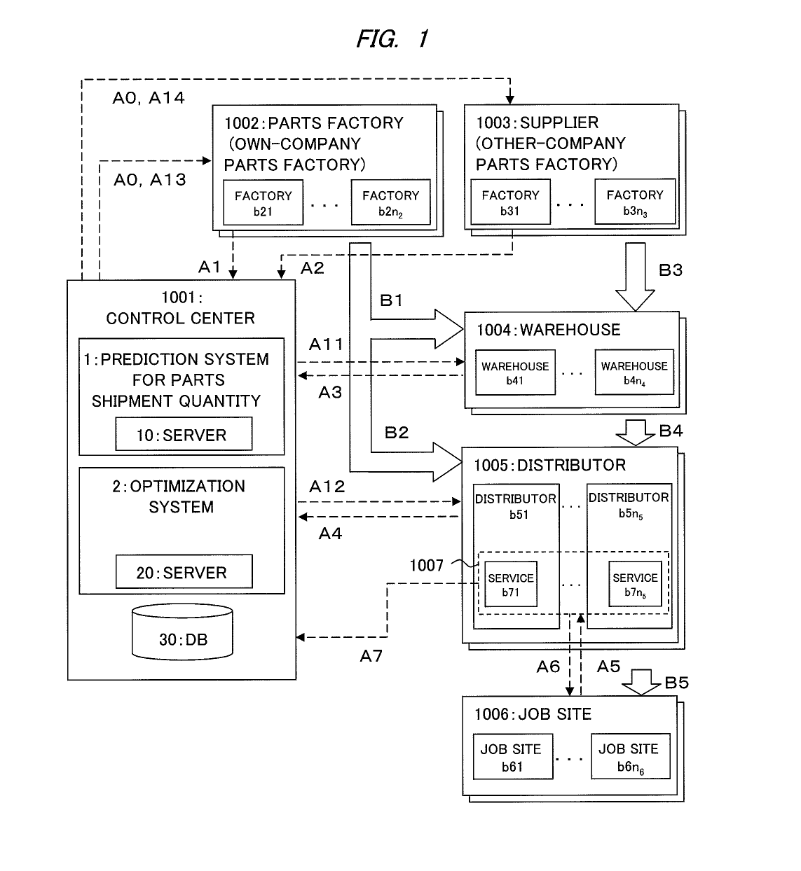

A system (a prediction system for the parts shipment quantity) 1 of a first embodiment of the present invention is explained with reference to FIGS. 1 to 13. The system 1 of the first embodiment includes the prediction unit 100 which predicts the parts shipment quantity in accordance with the product data D1, the parts shipment data D2, and the prediction condition D3 including the assumed parts-purchase period H (including the charge-free warranty period) and which outputs the prediction result data D0.

[Overview]

FIG. 1 illustrates a system overview including the prediction system 1 for the parts shipment quantity and its related elements. Overall, the system has: a control center 1001; an own-company parts factory 1002; an other-company parts factory (a supplier) 1003; a warehouse 1004; a distributor 1005; a job site 1006; and a service department 1007, and they are connected via a communication network or via physical delivery not illustrated. Broken arrows denoted by “A0” and others indicate the communication over the communication network, and arrows denoted by “B1” and others indicate the physical delivery (parts delivery). There is one or more of the elements (1002 to 1007), and each element includes a supporting computer (such as a server or a terminal). Reference symbols such as b21 to b2n₂ in each of the elements (1002 to 1007) indicate components of each of the elements. For example, reference symbols b21 to b2n₂ in the own-company parts factory 1002 indicate n₂ own-company parts factories, and reference symbols b5₁ to b5n₅ in the distributor 1005 indicate n₅ distributors.

The control center 1001 includes personnel and an information processing system which perform a control task regarding sales management of the product and the parts and others. In the control center 1001, the prediction system 1 for the parts shipment quantity (in FIG. 2) of the first embodiment is provided. The prediction system 1 for the parts shipment quantity is configured to include a general device such as a server 10 (FIG. 2). The server 10 includes the prediction unit 100 (FIG. 2) described later and others so as to achieve the prediction process for the parts shipment quantity and others by software program processing (processing by a program of the present embodiment) or others.

Also, in the control center 1001, provided are a computer which performs information processing regarding sales management of an existing product and parts and others, a DB (database) 30 which stores information associated with the prediction and other information (containing data information to be sent to and received from each related element) so as to be utilized and shared in the control center 1001, network facilities such as a LAN, an optimization system 2 described later, and others.

Each of the own-company parts factory 1002 and the other-company parts factory (supplier) 1003 includes a server which performs a parts-shipment processing and others so as to perform the parts-shipment processing based on an instruction, information, and others regarding a parts order A0 from the control center 1001. The shipped parts are delivered (B1, B2, and B3) from the own-company parts factory 1002 and the other-company parts factory 1003 to the warehouse 1004 and the distributor 1005.

The warehouse 1004 and the distributor 1005 keep the parts stock based on instruction and information (parts stocks A11 and A12) from the control center 1001. The parts are delivered from the warehouse to the distributor (B4), and are delivered from the distributor to the job site (B5).

Also, pieces of actual parts-shipment information (A1, A2, A3, and A4) are transmitted from the own-company parts factory 1002, the other-company parts factory 1003, the warehouse 1004, the distributor 1005, and others to the control center 1001, respectively. The server 10 of the control center 1001 obtains and stores these pieces of the actual parts-shipment information (which is reflected on a parts-shipment data storage unit 112 of FIG. 2).

The job site 1006 is a customer job site where the product (for example, the construction machine) associated with the parts is installed and used. Each of the distributors b51 to b5n₅ has the service department 1007 which performs a service associated with the product and the parts (such as maintenance and operation, customer support, and sales) for the job site (customer). From the service department 1007 to the job site 1006, exchange of services, sales, and others (A5) including the shipment (introduction) of the product and the part is performed. Also, from the job site 1006 to the service department 1007, exchange of services, sales, and others (A6) including removal of the product or the part and others is performed. The exchange A6 contains product removal information. The service department 1007 transmits these pieces of information (the product shipment information and the product removal information) (A7) to the control center 1001. From the service department 1007 and others, the control center 1001 obtains and stores product information (A7) (which is reflected on a product data storage unit 111 of FIG. 2).

Also, information regarding the assumed parts-purchase period H (such as the charge-free warranty period) can be inputted (set) or checked on a screen by the administrator (user) of the present system 1 or others (which is reflected on a prediction condition storage unit 113 of FIG. 2).

Then, in the present system 1, the parts can be ordered to, for example, the own-company parts factory 1002 and the supplier 1003 (A13 and A14) based on the prediction result data of the parts shipment quantity (D0 of FIG. 2). Also, the present system 1 can make a request to keep the stock to, for example, the warehouse 1004 and the distributor 1005 (A11 and A12), based on the prediction result data of the parts shipment quantity (D0 of FIG. 2).

In the own-company parts factory 1002, the other-company parts factory 1003, the warehouse 1004, the distributor 1005, the job site 1006, and the service department 1007, various types of parts are handled.

[System Configuration]

FIG. 2 illustrates a structure example of the prediction system 1 for the parts shipment quantity of the embodiment. The present system 1 is illustrated as being achieved by the server 10. As a functional block structure, the server 10 has: the prediction unit (prediction unit for the parts shipment quantity) 100; a data input processing unit 101; a data output processing unit 102; the customer-owned product data storage unit 111; the parts-shipment data storage unit 112; the prediction-condition storage unit 113; a prediction-result-data storage unit 114; and others. The prediction unit 100 performs a main process (the prediction process). The data input processing unit 101 and the data output processing unit 102 performs an input process and an output process (such as screen display process) for information data regarding the prediction process.

As a hardware/software structure, the server 10 is configured of a general calculating device 200, an input/output I/F device 201, a storage device 202, a bus 205, and others. The calculation device 200 includes a processor, a memory, and others, and the processor retrieves a program code onto the memory and executes it so as to achieve the processes including the prediction unit 100, the data input processing unit 101, the data output processing unit 102. The storage device 202 is configured of a memory, a disk, or an external storage, and others. The bus 205 is connected to an external communication network or others via the input/output I/F device 201.

The input/output I/F device 201 includes a network I/F device, a storage I/F device, and others, and has each device and an external medium including an input device (including a keyboard, a mouse, etc.) and an output device (including a display and a printer) connected thereto, and besides, provides a predetermined user interface. More particularly, it provides a graphical user interface screen (a display screen). On that screen, the user can check and input the information. Note that a main process including calculation of a numerical value or others at the data input processing unit 101 and the data output processing unit 102 in the input/output I/F device 201 may be assumed to be performed practically by the calculation device 200 (the prediction unit 100).

The data input processing unit 101 receives the input of the data information from the user interface (the screen) and the external medium, etc., and transfers the information which has been subjected to the input processing to each of units (111 to 113) in the storage device 202 for storage. The process of the data input processing unit 101 includes, for example, a process of generating and displaying the input screen, a process of receiving the information from an external system, and others.

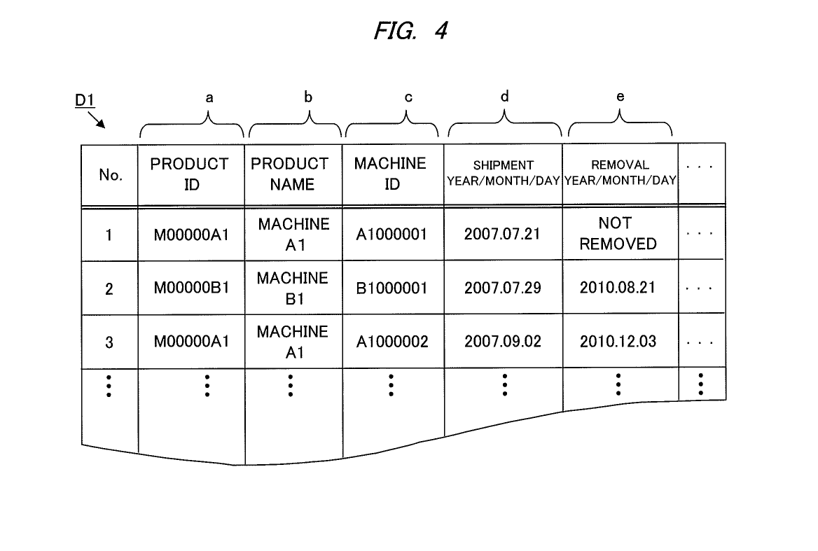

The customer-owned product data storage unit 111 stores product data (customer-owned product data) (which is taken as D1) transferred from the data input processing unit 101. The product data D1 contains information regarding an actual shipment year/month/day for each product (customer-owned product), and a removal year/month/day if the product has been already removed (described later with reference to FIG. 4). The customer-owned product data storage unit 111 transfers the product data D1 to the prediction unit 100.

The parts-shipment data storage unit 112 stores the parts-shipment data (which is taken as D2) transferred from the data input processing unit 101. The parts-shipment data D2 contains the actual shipment year/month/day information and the quantity information for each parts. The parts-shipment data storage unit 112 transfers the parts-shipment data (D2) to the prediction unit 100.

The prediction-condition storage unit 113 stores data information regarding a prediction condition (which is taken as D3) transferred from the data input processing unit 101. The prediction condition D3 contains information regarding the assumed parts-purchase period H. The prediction condition storage unit 113 transfers the prediction condition D3 containing the assumed parts-purchase period H to the prediction unit 100.

The pieces of necessary data (D1, D2, and D3) are inputted from the respective storage units (111, 112, and 113) to the prediction unit 100 to perform the prediction process for the parts shipment quantity, and the resulted prediction result data D0 is stored in the prediction-result data storage unit 114. The prediction result data D0 contains information of a year/month-dependent prediction result of the future part shipment quantity for each parts. Also, the data output processing unit 102 receives the prediction result data D0 from the prediction-result data storage unit 114, and performs a process of outputting the data to the user interface (the screen) and the external medium. The process of the data output processing unit 102 includes, for example, a process of generating and displaying an output screen, a process of transmitting information to the external system, and others.

[Prediction Process]

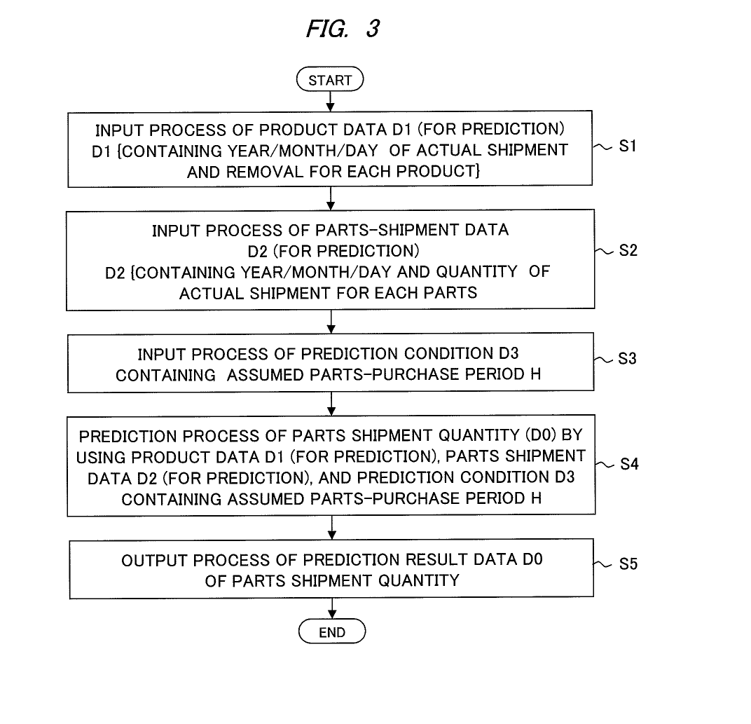

FIG. 3 is a flow (F1) of a process (a prediction process) of the prediction unit 100 of the prediction system 1 for the parts shipment quantity. A symbol “S1” and others represent process steps. At a step of S1, the input process on the production data D1 (for the prediction) from the storage unit (111) is performed in the prediction unit 100. At a step of S2, the input process of the parts-shipment data D2 (for the prediction) from the storage unit (112) is performed in the prediction unit 100. At a step of S3, an input process of the prediction condition D3 from the storage unit (113) is performed in the prediction unit 100. At a step of S4, the prediction unit 100 performs the prediction process for the parts shipment quantity by the calculation (described later) with the usage of the pieces of the data (D1, D2, and D3) inputted at the steps of S1 to S3. At a step of S5, the prediction unit 100 outputs the prediction result data D0, which is resulted from the step of S4, to the storage unit (114) for storage, and besides, performs an output process via the data output processing unit 102.

[Product Data D1]

FIG. 4 illustrates a table example of the customer-owned product data D1. The table has such items (in columns) as “No.” (row number), “product ID” (a), “product name” (b), “machine ID” (c), “shipment year/month/day” (d), “removal year/month/day” (e). The product ID denoted by “a” indicates information uniquely identifying a model of the product. The product name denoted by “b” is associated with the product ID denoted by “a”, and indicates information regarding a name, a model, a type, or others of the product (information in a format in accordance with the product as a management target). The “Machine ID” denoted by “c” indicates information uniquely identifying the products individually from each other, such as a serial number. The “Shipment year/month/day” denoted by “d” indicates the date information of the actual product shipment, which is based on A7 of FIG. 1 and others. The “Removal year/month/day” denoted by “e” indicates the date information of the actual product removal, which is based on A7 of FIG. 1 and others.

The “Customer-owned product” indicates a product purchased and owned by a customer (a product shipped to the job site 1006) In other words, it indicates a product sold from the company to the customer and installed and used at the job site 1006 (for example, a construction site) of the customer. As examples of the product, in addition to the above-described construction machine, an electric generator installed in an electric power plant and others are cited.

[Parts-Shipment Data D122]

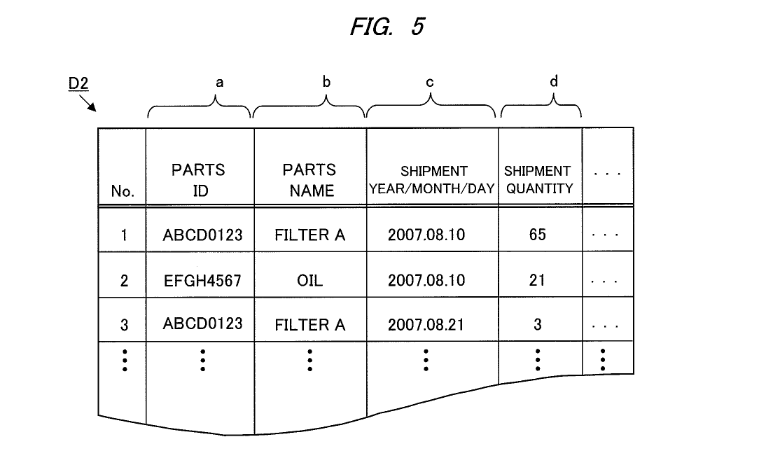

FIG. 5 illustrates a table example of the parts-shipment data D2. The table has items of “No.”, “parts ID” (a), “parts name” (b), “shipment year/month/day” (c), “shipment quantity” (d), and others. The “Parts ID” denoted by “a” indicates information uniquely identifying a model of the parts. The “parts name” denoted by “b” is associated with the parts ID denoted by “a”, and indicates information regarding a name, a type, other attribution, and others of the parts (information in a format in accordance with the parts as a management target). The “Shipment year/month/day” denoted by “c” indicates the date information of the actual parts shipment, which is based on A1 to A4 of FIG. 1 and others. The “Shipment Quantity” denoted by “d” indicates quantity of the parts shipment, which is based on A1 to A4 of FIG. 1 and others.

As described above, the “parts” includes not only parts as a component of the product but also consumable parts and replacement parts associated with the operation, the maintenance, and others for the product. For example, when the product is the construction machine, as the parts associated with the operation, the maintenance, and others, a filter, oil (working oil), and a battery are cited. In the example of FIG. 5, examples of numerical values regarding the parts “filter A” and the parts “oil” are described.

[Prediction-Result Data D0]

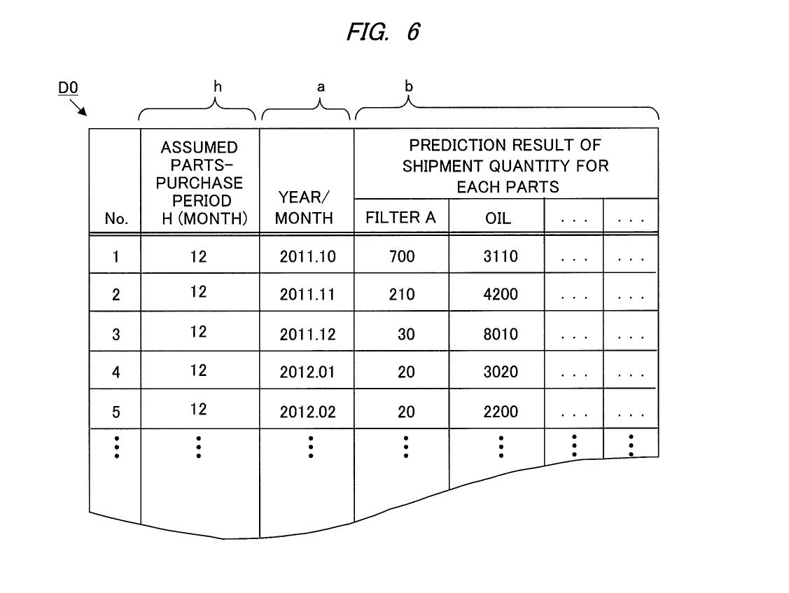

FIG. 6 illustrates a table example of the prediction-result data (D0). The table has items of “No.”, “year/month” (a), “prediction result (value) of a shipment quantity for each parts” (b), “assumed parts-purchase period H (months)” (h), and others. The “Year/Month” denoted by “a” indicates the year/month serving as a unit of the prediction. The “Prediction Result of Shipment Quantity for Each Parts” denoted by “b” indicates a numeral value of the prediction result of the future parts shipment quantity for each parts (part ID). In the item “h”, an H value is illustrated in a unit of month. In the present embodiment, note that the parts IDs are the same as each other if they have the same parts name (in FIG. 5), and the prediction is made for each parts name (parts ID).

In the example of FIG. 6, the predicted values of the shipment quantity regarding the parts “filter A” and the parts “oil” are described for each future year/month. Also if other parts (such as the “filter B”, the “battery”, and others) exist, that is similarly described.

[Input Screen]

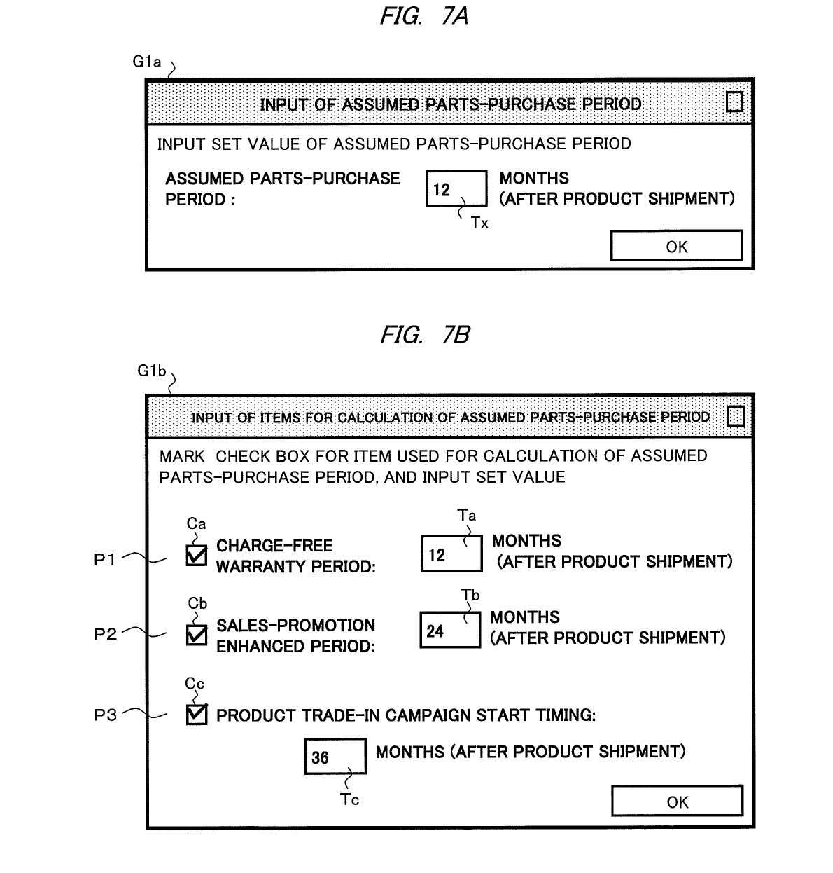

FIGS. 7A and 7B illustrate two examples of the input screen when the input of the information regarding the assumed parts-purchase period H from the user is accepted via the user interface (the input/output I/F unit 201). Note that this process is performed mainly by the data input processing unit 101 and the calculation unit 200 (the prediction unit 100), etc. The assumed parts-purchase period H determined by the present input is reflected on the prediction condition D3.

FIG. 7A illustrates a screen G1a used when the assumed parts-purchase period H configuring the prediction condition D3 is directly inputted (set). On the screen G1a, the user inputs the number of months since the product shipment based on the time of the product shipment as a reference (0). In the present system, this value (Tx) is directly taken as the value of the assumed parts-purchase period H.

FIG. 7B illustrates a screen G1b used when each item information for the calculation of the assumed parts-purchase period H is inputted. On the screen G1b, inputs of one or more (three types in this example) parameters (periods) serving as factors for determining the assumed parts-purchase period H is accepted, and a process of calculating (determining) one assumed parts-purchase period H is performed by using the input values so as to be reflected on the prediction condition D3 including the assumed parts-purchase period H. As the three types of factors for determining one assumed parts-purchase period H, this example includes the charge-free warranty period (P1), a sales-promotion enhanced period (P2), and a product trade-in campaign start timing (P3).

In check boxes (Ca, Cb, and Cc) for the respective parameters (P1, P2, and P3) on the screen G1b, it can be selected by the user whether to use the input values (Ta, Tb, and Tc) of the corresponding periods to calculate the assumed parts-purchase period H. FIG. 7 exemplifies a state that “Ta=12 months, Tb=24 months, and Tc=36 months”. An equation for the calculation of the assumed parts-purchase period H can be defined by a polynomial function or others with taking the period value of the checked (marked) parameter as a variable. For example, the following Equation (1) can be used. However, values of terms “Ca”, “Cb”, and “Cc” are 1 when the check is ON and are 0 when the check is OFF. The period values (Ta, Tb, and Tc) of the respective parameters are, for example, the number of months since the product shipment. Also, weighting (coefficients) Ka, Kb, and Kc are added to the respective parameters. The weighting Ka, Kb, and Kc may be set by the user.

[Equation 1]

H=Ca×Ka×Ta+Cb×Kb×Tb+Cc×Kc×Tc (1)

[Period]

Various periods (examples of FIG. 7) serving as the factors (parameters) for determining the assumed parts-purchase period H will be described below.

As described above, the charge-free warranty period (Ta) in the item P1 is a period with taking a product shipping date as a starting point, during which execution of the maintenance of the product purchased by the customer in failure of the product is warranted by a manufacturer (a business operator or product/parts manufacturer/distributor side) at no charge under a condition that the customer definitely uses the manufacturer's genuine parts as the consumable parts or the replacement parts for which periodic replacement is recommended. Generally, there is a tendency such that, while the customer actively purchases the manufacturer's genuine parts during the charge-free warranty period of the product in order to be warranted, the customer purchases the non genuine parts which is cheaper after the end of the warranty period in order to reduce a purchase price of the maintenance parts.

The sales-promotion enhanced period in the item P2 is a period with taking the product shipping date as the starting point, during which the manufacturer actively performs sales promotion (such as visiting the customer and sending a direct mail) so as to encourage the customer to purchase the manufacturer's genuine parts. In addition, a period for various types of campaigns such as discount sale of the product may be handled. Generally, during the sales-promotion enhanced period, it is easy and cheap to purchase the manufacturer's genuine parts (such that the parts can be purchased when a manufacturer's sales representative visits the customer without necessary of the customer own visiting to a shop), and therefore, there is a tendency to increase the purchase of the manufacturer's genuine parts. After the sales-promotion enhanced period, it is comparatively not easy to purchase the parts, and therefore, there is a tendency to increase the purchase of the non genuine parts. Therefore, it is experimentally assumed that, when this period is long, the product shipment quantity is increased, and the parts shipment quantity is also increased.

The product trade-in campaign start timing in the item P3 is a timing of campaign start with taking the product shipping date as the starting point, at which an old product already owned by the customer is traded in by the manufacturer under a condition that the customer purchases a new product. Generally, there is a tendency such that, while the customer purchases the parts (genuine parts) for the old product before the start of the campaign, the customer plans the purchase of the new product for the replacement after the start of the campaign, and therefore, stops the purchase of the parts for the old product.

Accordingly, generally, the assumed parts-purchase period is longer as the charge-free warranty period and the sales-promotion enhanced period of the product are longer, and besides, as the product trade-in campaign start timing is later. For this reason, normally, Ka, Kb, and Kc may be set as a state that “0≦Ka, Kb, and Kc≦1” and “Ka+Kb+Kc=1”.

[Output Screen]

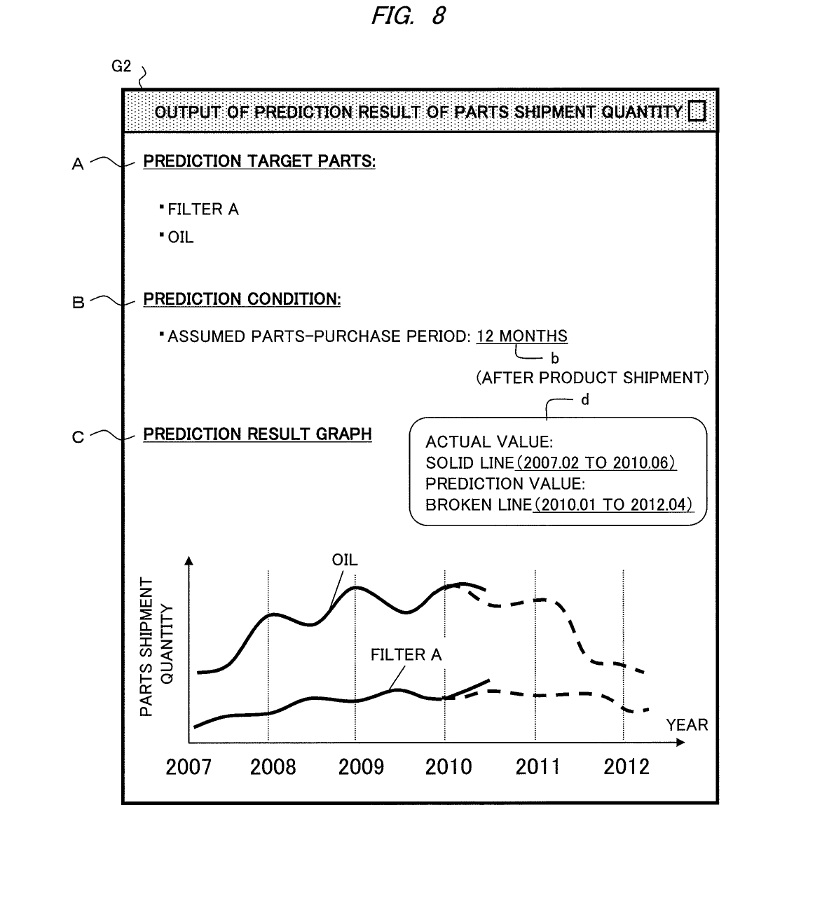

FIG. 8 illustrates an example of an output screen (G2) when the prediction-result data D0 of the parts shipment quantity is outputted to the user via the user interface (the input/output I/F unit 201). Note that the present process is performed mainly by the data output processing unit 102 and the calculation unit 200 (the prediction unit 100), etc. An example of display contents on the screen G2 of FIG. 8 includes (A) a name of a prediction target parts, (B) the prediction condition (the assumed parts-purchase period H), and (C) a prediction result graph. The name of the prediction target part in the item “A” is displayed based on “a parts name”, “a parts ID”, or others managed in the table D2 of FIG. 5. In the display in the item “B”, the value of the assumed parts-purchase period H is displayed in a section “b”.

In the prediction result graph in the item C, for each parts (such as “the filter A” and “the oil”), an actual value and a prediction value of the parts shipment quantity on each year/month are displayed by, for example, a sold line and a broken line, respectively. In this manner, the prediction value can be checked, and the prediction value and the actual value can be compared with each other and others by the user. In the display in the item C, a data period obtained for each of the actual value and the prediction value is displayed in a section “d”.

[Prediction Process (FA)]

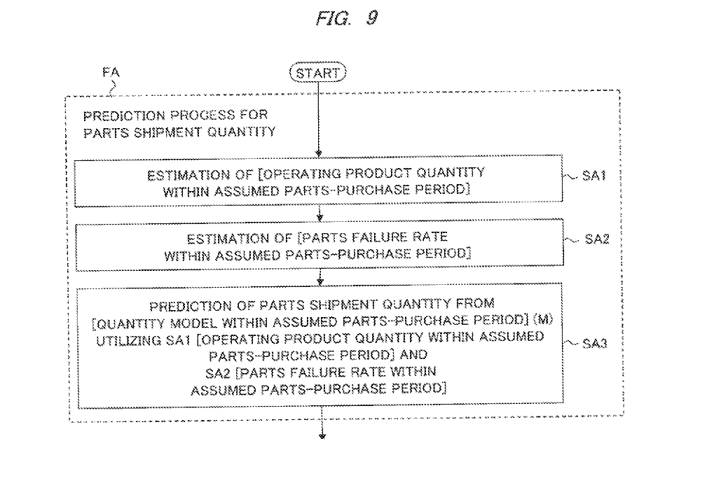

A process flow (FA) of FIG. 9 illustrates a first detailed process flow example (FA) regarding the prediction process for the parts shipment quantity at the step S4 of the process flow (F1) of FIG. 3. The flow FA has three process steps SA1, SA2, and SA3. At the step SA1, a process of estimating [the operating product quantity within the assumed parts-purchase period] which indicates the operating product quantity within the assumed parts-purchase period H is performed by using a prediction expression defined by the following Equation (2) is performed. However, it is assumed that the actual data (D1) of the product shipment/removal quantities is obtained during only a period from 0 to “n₀” months and that a final predicted month “n” has a relation of “n>n₀”. Also, “A_plan” indicates a planned value of A, and “A_pred” indicates a prediction value or an estimated value of A.

[Equation 2]

x_pred(n)=A1+A2=(B1−B2)+(B3−B4) (2)

A1: [the prediction value of the quantity which is operating on “n” month and whose elapse time after the shipment is within H among the shipped products from 0 to n₀ month]
A2: [the prediction value of the quantity which is operating on “n” month and whose elapse time after the shipment is within H among the shipped products from n₀+1 month to n month]
B1: the cumulative product shipment quantity from 0 to n₀ month:

Σ_{i=0 to n0}p(i)τ(n−i)

B2: the predicted value of the cumulative product removal quantity on 0 to n month:

Σ_{i=0 to n}p(i)τ(n−i)λ(n−i)

B3: the planned value of the cumulative product shipment quantity on n₀+1 to n month:

Σ_{i=n0+1 to n}p_plan(i)τ(n−i)

B4: the predicted value of the cumulative product removal quantity on n₀+1 to n month:

Σ_{i=n0+1 to n}p_plan(i)Σ(n−i)λ(n−i)

The meanings of the symbols in the Equation (2) are as follows:

x_pred(n): a prediction value of the operating product quantity within the assumed parts-purchase period H

n₀: a final month with the actual product-shipment data

n: a final prediction month (n>n₀)

p(i): an actual value of the product shipment quantity on i-th month

p_plan(i): a planned value of the product shipment quantity on i-th month

λ(j): a failure rate of the product at a moment when the cumulative number of the used months of the product is j months (0≦λ≦1)

τ(j): a function which takes 1 in a state of “0≦j≦H” and 0 in a state of “H<j” for the cumulative number j of the used months of the product

λ₀(j): a true failure rate

r_{c}: a market capture ratio

Also, the failure rate λ(j) corresponds to a value (λ₀(j)×r_{c}) obtained by multiplying the true failure rate λ₀(j) by the market capture ratio r_{c}. The failure rate λ(j) can be estimated by a cumulative hazard method, which is a general method, by using the data (D1) of the actual quantities of the product shipment/removal.

In the Equation (2), the first term (B1) represents the cumulative shipment quantity from 0 to n₀ months with the actual product-shipment data. The second term (B2) represents the cumulative removal quantity from 0 to n months obtained by convolution integral between the actual value p of the product shipment quantity and the product failure rate λ in a period from 0 month to a prediction target month (an n-th month).

In the third term (B3) and the fourth term (B4), the cumulative shipment quantity and the cumulative removal quantity from n₀+1 to n months without the actual product shipment data can be calculated by utilizing a planned value of the shipment quantity or production quantity instead of the actual product-shipment data. The third term (B3) represents a planned value of the cumulative shipment quantity from n₀+1 to n months without the actual product-shipment data. The fourth term (B4) represents a prediction value of the cumulative removal quantity of the product from n₀+1 to n months obtained by convolution integral between a planned value p_plan of the product shipment quantity and the product failure rate λ in a period from n₀+1 month to the prediction target month (the n-th month).

Here, the convolution integral is a general name of calculation for predicting the cumulative removal quantity of the shipped products on the i-th month at a moment of the prediction target month (the n-th month) and counting the cumulative removal quantity for “i=0 to n” by multiplying the quantity p(i) of the shipped products or the planned quantity p_plan(i) on the i-th month by a product failure rate λ(n−i) at a moment of the cumulative used months “n−1” during which the shipped products on the i-th month have been used by the prediction target month (the n-th month).

Next, at the step SA2, a process of estimating [a parts failure rate (a parts failure rate within the assumed parts-purchase period) is performed (described later).

Next, at the step SA3, a prediction process for the parts shipment quantity is performed by [a model for the quantity within the assumed parts-purchase period] (referred to as “M”) utilizing [the operating product quantity within the assumed parts-purchase period] estimated at the step SA1 and [the parts failure rate] estimated at the step SA2. At the step SA3, the process is performed by using [the model for the quantity within the assumed parts-purchase period] (M) as expressed in Equation (3).

[Equation 3]

y_{—}_{^{pred}}(n)=(1+f_{—}_{^{pred}}(n))×{a₀×x_{—}_{^{pred}}(n)+b}=F_{—}_{^{pred}}(n)×T_{—}_{^{pred}}(n) (3)

n: prediction target month
y_{—}_{^{pred}}(n): a predicted value of the parts shipment quantity
f_{—}_{^{pred}}(n): an estimated value of a seasonal parts failure rate
a₀: a base-parts failure rate
x_{—}_{^{pred}}(n): a predicted value of an operating product quantity (the quantity of all operating products or the quantity of operating products within the period) (Equation (2))
b: correction intercept
F_{—}_{^{pred}}(n): an estimated value of seasonal variation
T_{—}_{^{pred}}(n): an estimated value of trend
x_{—}_{^{pred}}_{—}_{^{all}}(n): a predicted value of the operating product quantity for all products

However, in the above description, states that “T_pred(n)=a₀×x_pred_{—}_{^{all}}(n)+b” and “F_pred(n)=1+f_pred(n)” are established.

The estimation of the [parts failure rate] at the step SA2 is performed by the following procedure ((1) to (5)).

(1) An annual (one-year) periodic seasonal variation is removed by taking a moving average of the data y(i) of the actual shipment quantities for the maintenance parts having an order of one year=twelve months, and the data obtained after this removal is defined as an actual value T(i) of the trend (i=7 to n−7). That is, the following Equation (4) is established.

[Equation 4]

T(i)={Σ_{j=i-5 to i+5}y(j)+(y(i−6)+y(i+6))/2}/12 (4)

(2) A value obtained by dividing the data y(i) of the actual shipment quantity for the maintenance parts by the trend T(i) is defined as an actual value F(i) of the seasonal variation (i=7 to n−7). That is, the following Equation (5) is established.

[Equation 5]

F(i)=y(i)/T(i) (5)

(3) Regarding terms a₀ and b, in order to fit the actual trend value, the terms a₀ and b are estimated by, for example, the least square method so as to set a state that “the actual value T(i) of the trend=a₀×x_pred_{—}_{^{all}}(n)+b”.

(4) An actual value f (n) of a seasonal parts failure rate is calculated by using the actual value F(n) of the seasonal variation. That is, the following Equation (6) is established.

[Equation 6]

f(n)=F(n)−1 (6)

(5) From the actual value f (n) of the seasonal parts failure rate, a seasonal parts failure rate model f_pred(n) (note a state that “f_pred(n)=f_pred(n+12)”) is constructed.

As a method of constructing this model f_pred(n), a method of taking an average value of the seasonal parts failure rates on the same month over past several years, a method of application to a periodic function such as a trigonometric function, and others are cited.

Also, in order to improve noise resistance, a value fₖ(n) obtained by previously smoothing the actual values f(n) of the seasonal parts failure rates for the respective months by the moving average with the order “k” is used. Note that, in a viewpoint of a physical sense, such a state as “k=3 (three months in one season forming four seasons)” or “k=6 (a half year centering on the summer and centering on the winter) is desired.

[Prediction Process (A)—Prediction Model for Parts Shipment Quantity]

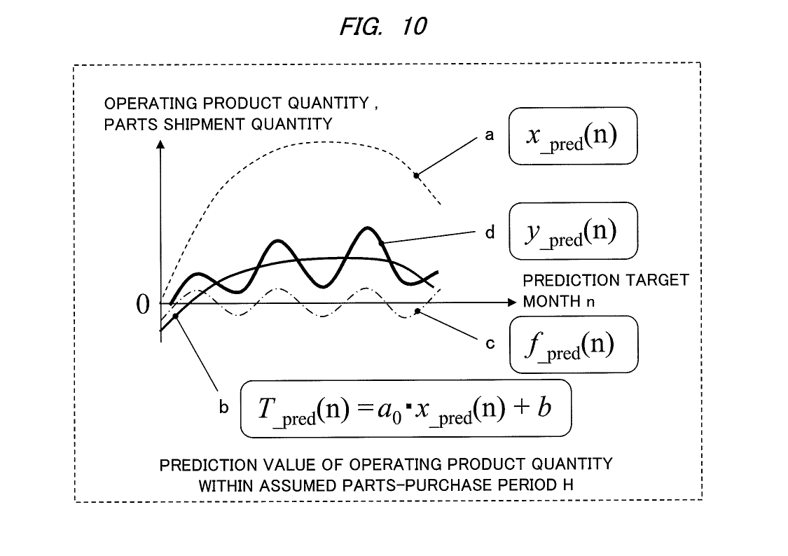

FIG. 10 illustrates the prediction value of the operating product quantity within the assumed parts-purchase period H in the above-described process (the prediction model for the parts shipment quantity) and others. A horizontal axis represents the prediction target month “n”, and a vertical axis represents the operating product quantity and the parts shipment quantity. A symbol “a” represents the predicted value x_pred(n) of the operating product quantity predicted by the Equation (2). A symbol “b” represents the estimated value T_pred(n) of the trend predicted by the Equation (3) based on x_pred(n) in the “a”. A symbol “c” represents the estimated value f_pred(n) of the seasonal parts failure rate by the Equation (3). A symbol “d” represents the predicted value y_pred(n) of the parts shipment quantity by the Equation (3), calculated from an addition of the “b” and “c”.

[Prediction Process (B)]

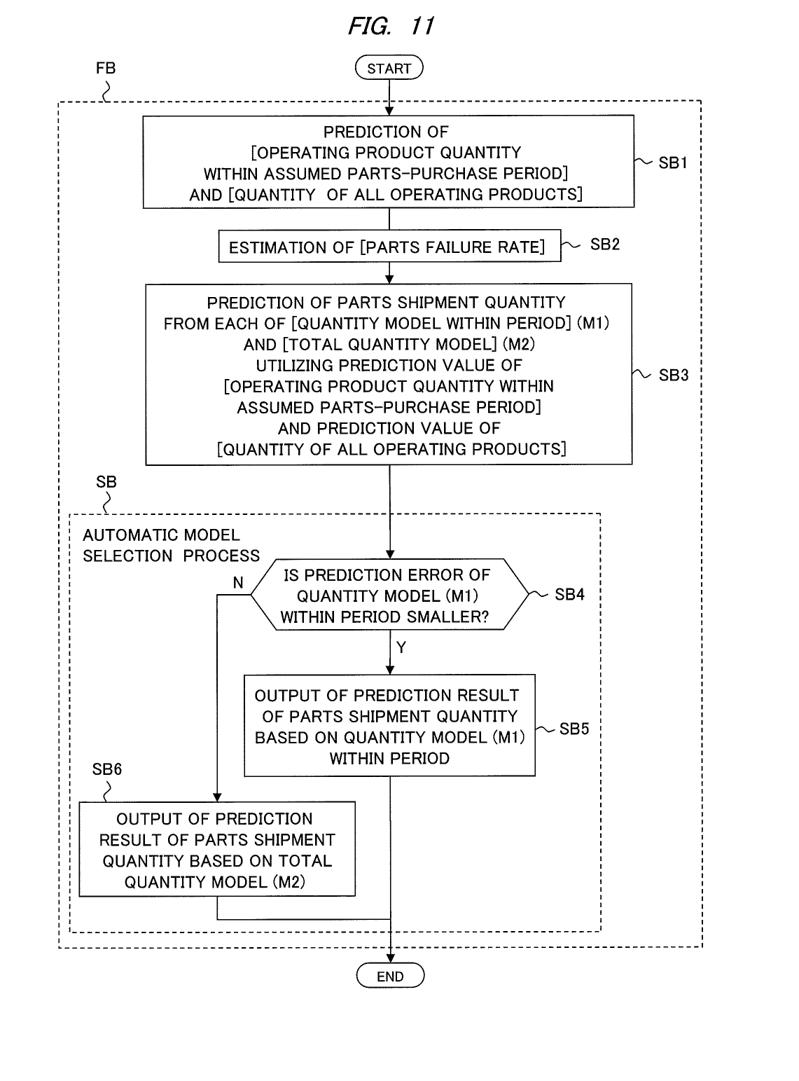

A process flow (FB) of FIG. 11 illustrates a second example

(FB) of the detailed process flow regarding the prediction process for the parts shipment quantity at the step S4 of the process flow (F1) of FIG. 3. The present process flow (FE) is configured of steps SB1, SB2, SB3, and an automatic model selection process (SB), etc. At the step SB1, the operating product quantity is predicted by using, in addition to [the operating product quantity within the assumed parts-purchase period] as the same as that of the step SA1 of FIG. 9, [the quantity of all operating products] (corresponding to the operating product quantity predicted by the Equation (2) when τ(j) in the Equation (2) is defined so as to always have a relation of “τ(j)=1”) which is the operating product quantity counted regardless of either that the cumulative period from the product shipping date is within or without the assumed parts-purchase period. A process content at the step SB2 is similar to that at the step SB2 of FIG. 9.

At the step SB3, the parts shipment quantity is predicted by using, in addition to the model for the quantity within the assumed parts-purchase period at the step SB2 (the model by [the operating product quantity within the assumed parts-purchase period]) (a first model: referred to as M1), a model for the total quantity (a second model: referred to as M2) corresponding to the Equation (2) when τ(j) in the Equation (2) is defined so as to always have the relation of “τ(j)=1”).

In the automatic model selection process (SE), the prediction unit 100 determines at the step SB4 whether the first model (M1) has a smaller prediction error or not. If the prediction error is smaller (Y), the prediction result of the parts shipment quantity based on the first model (M1) is outputted at the step SB5. If not (N), at the step SB6, the prediction result of the parts shipment quantity based on the second model (M2) is outputted.

[Prediction Process (B)—Prediction Model for Parts Shipment Quantity]

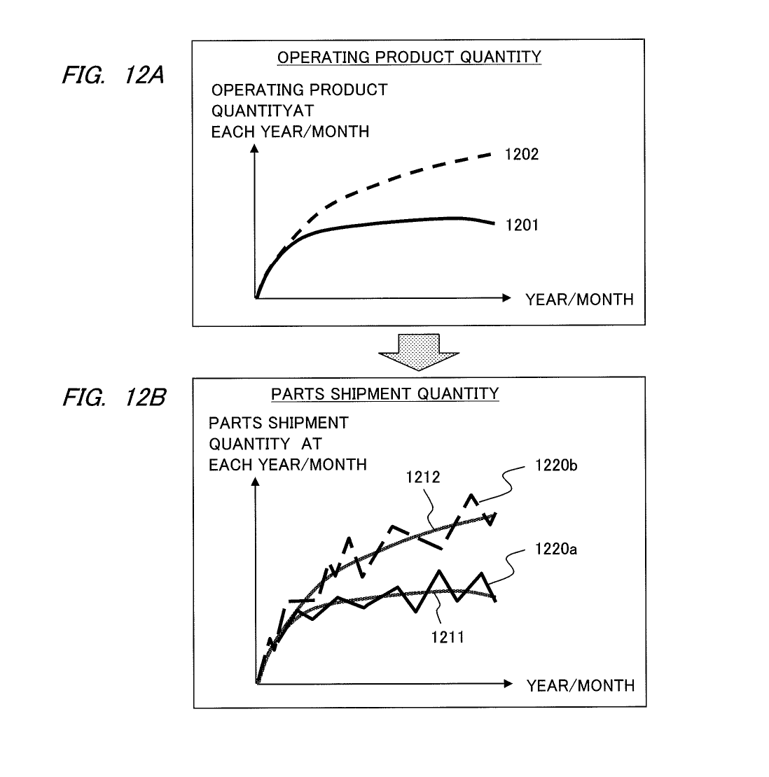

FIGS. 12A and 12B illustrate image examples of the prediction model (M: M1 and M2) for the parts shipment quantity to be selected in the prediction process of FIG. 11. FIG. 12A illustrates the operating product quantity, and FIG. 12B illustrates an image of the parts shipment quantity predicted by the prediction model (M) for the parts shipment quantity in accordance with the operating product quantity illustrated in FIG. 12A. In FIG. 12A, a horizontal axis represents year/month, and a vertical axis represents the operating product quantity for each year/month. A numerical symbol “1201” represents [the operating product quantity within the assumed parts-purchase period] which is the product quantity within H. A numerical symbol “1202” represents [the quantity of all operating products].

In FIG. 12B, a horizontal axis represents year/month, and a vertical axis represents the parts shipment quantity for each year/month. A numerical symbol “1211” represents a prediction value of the parts shipment quantity among the parts shipment quantities in FIG. 12B, which is calculated by substituting [the operating product quantity within the assumed parts-purchase period] (1201) in FIG. 12A and the parts failure rate into the quantity model (M1) within the period. A numerical symbol “1212” represents a prediction value of the parts shipment quantity which is calculated by substituting [the quantity of all operating products] (1202) in FIG. 12A and the parts failure rate into the total quantity model (M2).

At this time, a numerical symbol “1220a” represents an image of an actual value of the product shipment in which the share of the manufacturer's genuine parts is decreased after H, and the prediction value 1211 in (M1) can predict the actual shipment 1220a with higher accuracy than that of the prediction value 1212 in (M2). In this case, the prediction value in (M1) can be automatically selected by the above-described automatic model selection process SB.

On the other hand, a numerical symbol “1220b” represents an image of an actual value of the product shipment in which the share of the manufacturer's genuine parts is kept high even after H, and the prediction value 1212 in (M2) can predict the actual shipment 1220b with higher accuracy than that of the prediction value 1211 in (M1). In this case, the prediction value in (M2) can be automatically selected by the above-described automatic model selection process SB.

[Prediction Process (B)—Example]

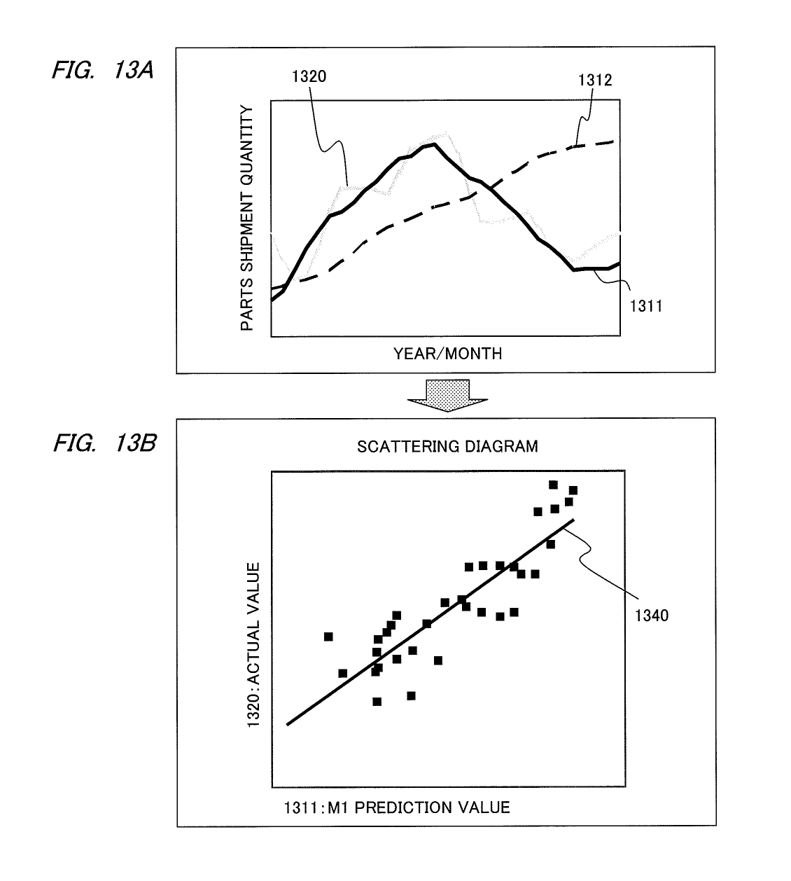

FIGS. 13A and 13B illustrate an example of the prediction process (B) of FIG. 11 for the actual data of the parts in which the share of the manufacturer's genuine parts is decreased after H.

In FIG. 13A, a horizontal axis represents year/month, and a vertical axis represents the parts shipment quantity. A numerical symbol “1320” represents an actual value (actual data) of the parts shipment quantity. A numerical symbol “1311” represents the prediction value of the quantity model (M1) within the period (described above) at this time. A numerical symbol “1312” represents the prediction value of the total quantity model (M2) (described above). Here, it is definite from the graph that the model M1 has the higher accuracy. Practically, the prediction value in M1 is automatically selected by the above-described automatic model selection process SB.

FIG. 13B illustrates a scatter diagram with taking a value of 1311 in FIG. 13A at this time on a horizontal axis and a value of 1320 on a vertical axis. A line of a numerical symbol “1340” represents linear approximation, and the scatter diagram goes along this line well, so that the prediction value in (M1) has a high correlation with the actual value. From the above description, it has been confirmed that this system can predict accurately the parts shipment quantity in which the share of the manufacturer's genuine parts is decreased after H.

### Modification Example

Also, in the above-described automatic model selection process (SB) of FIG. 11, an option of the selection is only either the quantity model (M1) within the period as the first model or the total quantity model (M2) as the second model. However, the following method may be performed. In the present system, a threshold is previously set, and it is determined that both models (M1 and M2) are inappropriate (the prediction accuracy is insufficient) if the prediction accuracy of the automatically-selected model (M1 or M2) is lower than the threshold, and a value obtained by weighting the prediction results of the first model (M1) and the second model (M2) and adding these weighted results is used as the prediction value of the parts shipment quantity. Alternatively, a prediction value obtained by a general method such as simple moving average is used.

[Effect]

According to the first embodiment, particularly, the parts shipment quantity can be accurately predicted regardless of whether the share of the manufacturer's genuine parts is decreased after the assumed parts-purchase period H or not.

### Second Embodiment

Next, a prediction system for the parts shipment quantity of a second embodiment has not only the function of the prediction for the parts shipment quantity as in the first embodiment but also an alert function for warning of the insufficiency of the prediction accuracy in accordance with a degree of the error which is difference between the prediction value and the actual value.

[System Structure]

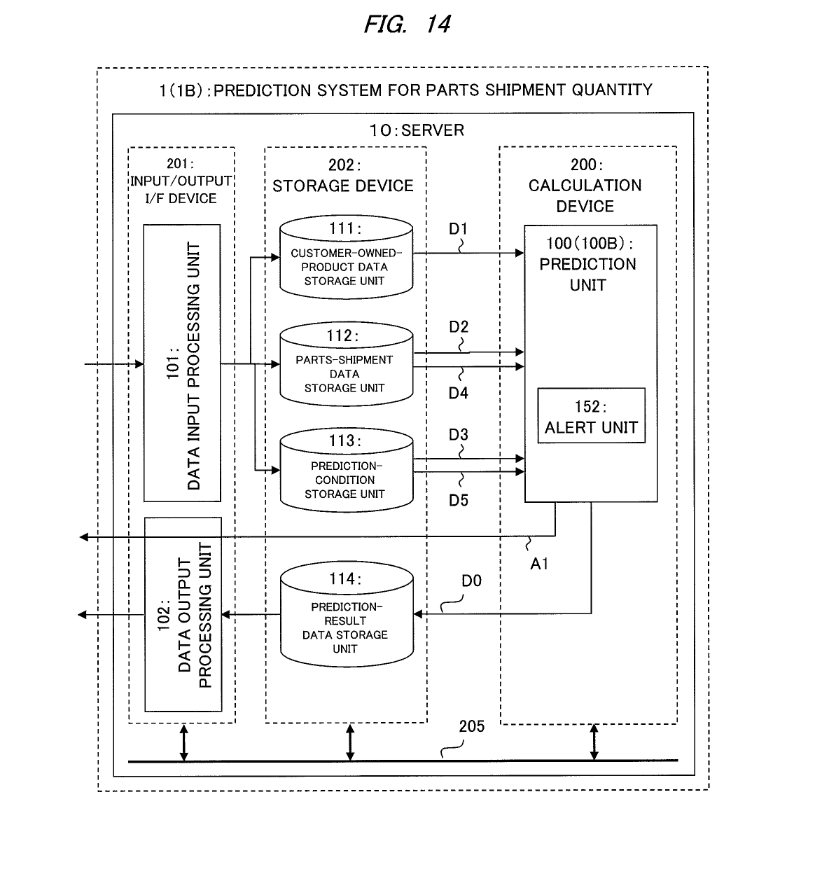

FIG. 14 illustrates a structure example of the prediction system 1 (system 1B) for the parts shipment quantity of the second embodiment. In the present system 1B, the prediction unit 100 (100B) has an alert unit 152 as a different point (a component of the alert function) from the system 1 of FIG. 1. Also, verification data D4 (verification data containing the year/month/day of the actual shipping for each parts and quantity thereof) is inputted from the parts-shipment data storage unit 112 to the prediction unit 100 (the alert unit 152), and information D5 containing an upper-limit value of the prediction error for the alerting is inputted from the prediction-condition storage unit 113 to the prediction unit 100B. Also, an alert A1 (an alert indicating the insufficiency of the prediction accuracy) is outputted from the prediction unit 100B (the alert unit 152) via the input/output I/F unit 201 (the data output processing unit 102) to a predetermined alert destination.

[Alert Process]

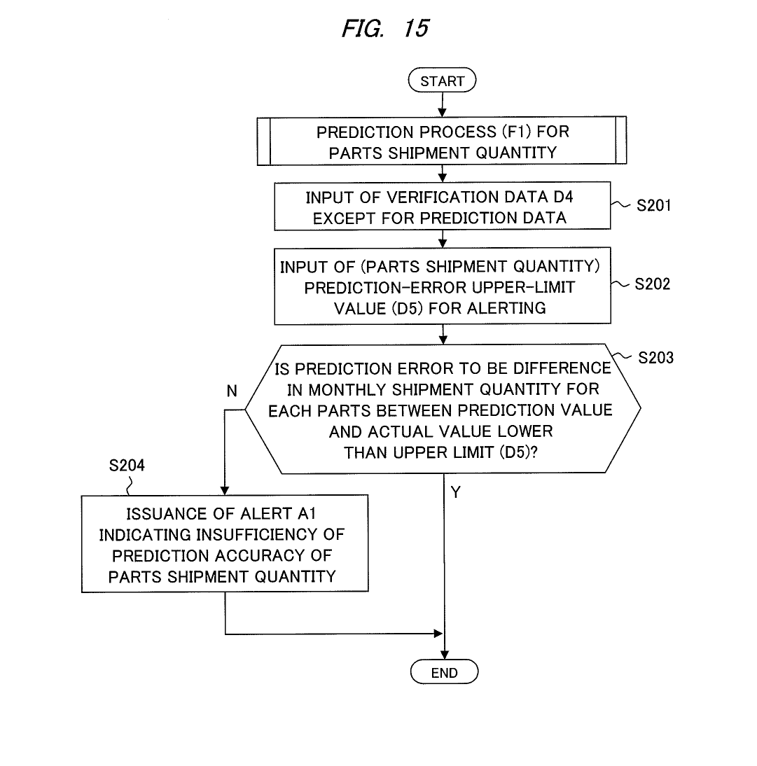

FIG. 15 illustrates a process flow example of the present system 1B. First, in a prediction process (F1) for the parts shipment quantity, the similar process to that of the process flow (F1) of FIG. 3 is performed. Next, at the following steps S201 to S204, a process regarding the alert function is performed.

At the step S201, the verification data D4 (data containing the year/month/day of the actual shipment for each parts and the quantity thereof) except for the prediction data (D2) is inputted to the prediction unit 100B (the alert unit 152). At the step S202, the prediction-error upper limit value (D5) (of the parts shipment quantity) for the alerting is inputted to the prediction unit 100B (the alert unit 152). At the step S203, the prediction unit 100B (the alert unit 152) determines whether the degree of the prediction error which is the difference between the prediction value and the actual value of the monthly shipment quantity for each parts is equal to or lower than the upper-limit value (D5). If the degree is equal to or lower than the upper-limit value (D5) (Y), the process ends. If the degree is larger than the upper-limit value (D125) (N), the prediction unit 100B (the alert unit 152) outputs (issues) an alert A1 indicating the insufficiency of the prediction accuracy of the parts shipment quantity at the step S204 to the predetermined alert destination (such as the user) via the input/output I/F unit 201 (the data output processing unit 102).

In Alert A1, for example, a message such that “Prediction error of Parts X exceeds the upper limit. Please check whether the actual shipment quantity or the prediction model has anomaly” is outputted onto the screen.

[Effect]

According to the second embodiment, only the parts with the anomaly in the prediction error can be automatically extracted and the alert can be issued even without particularly checking a huge number of all parts regarding whether the prediction error has the anomaly or not by an engineer.

### Third Embodiment

Next, in a third embodiment, a prediction system for the parts shipment quantity having a function of simulating the (period H-dependent) future parts shipment quantity is described. Note that the third embodiment may have both of the function of the first embodiment and the function of the third embodiment.

[System Structure]

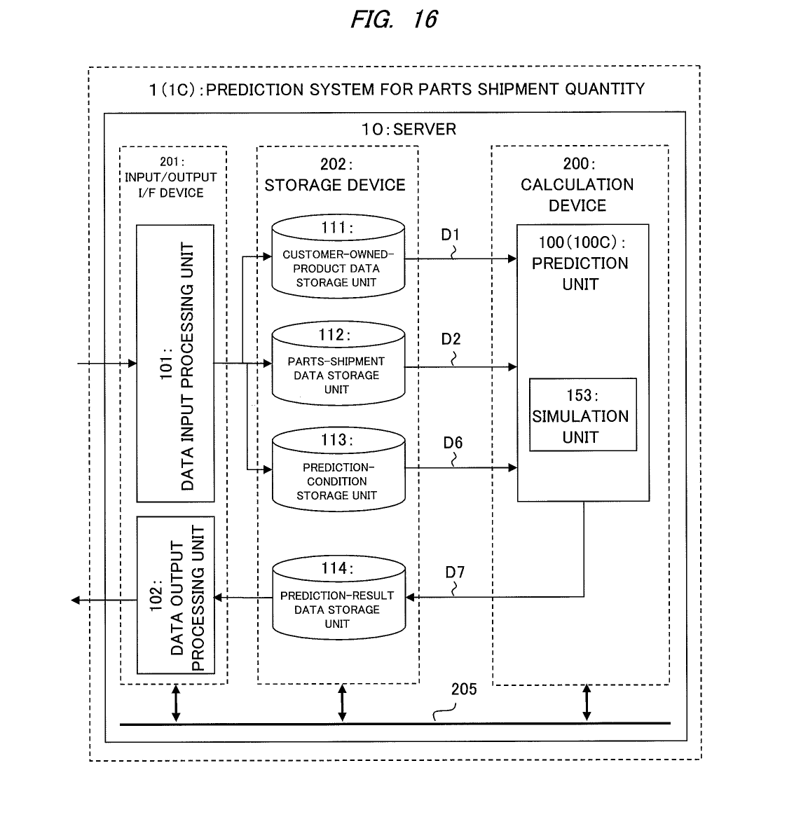

FIG. 16 illustrates a structure example of the prediction system 1 (system 1C) for the parts shipment quantity of the third embodiment. In the present system C1, the prediction unit 100 (100C) has a simulation unit 153 as a different point from the system 1 of FIG. 1. Also, instead of the prediction condition D3 including the assumed parts-purchase period H, information D6 of upper- and lower-limit values of the assumed parts-purchase period H for simulation (a prediction condition for the simulation) is inputted from the prediction-condition storage unit 113 to the prediction unit 100C (a simulation unit 153). Also, instead of the prediction result D0 of the future parts shipment quantity for each parts, a (assumed parts-purchase period dependent) prediction result D7 of the future parts shipment quantity for each parts is outputted from the prediction unit 100C (the simulation unit 153) as a simulation result.

[Simulation Process]

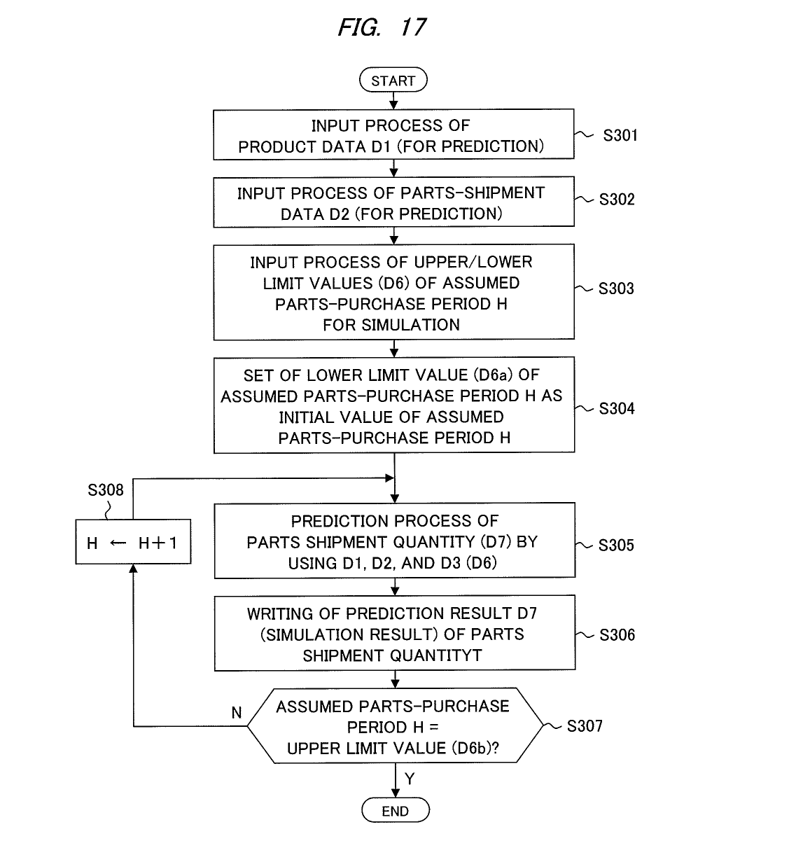

FIG. 17 illustrates a flow (F3) of the process (the simulation process) of the present system 1C. The process contents at steps S301, S302, and S305 are similar to those at the steps S1, S2, and S4 of FIG. 3. However, a step S305 is for the simulation process which is a prediction process for the parts shipment quantity (D7) using D1, D2, and D3 (D6). In the present simulation process, a period H-dependent prediction process is performed by taking the assumed parts-purchase period H as a variable (the period is varied in a long time and a short time).

At the step S303, the upper- and lower-limit values (D6) of the assumed parts-purchase period for the simulation are inputted to the prediction unit 100C (the simulation unit 153). These upper- and lower-limit values (D6) include a lower-limit value (D6a) and an upper-limit value (D6b). At the step S304, the prediction unit 100C (the simulation unit 153) sets the inputted lower-limit value (D6a) as an initial value of the assumed parts-purchase period H.

At the step S306, the prediction unit 100C (the simulation unit 153) writes the prediction result D7 (the simulation result) of the parts shipment quantity obtained at the step S305 into the prediction-result data storage unit 114. At the step S307, the prediction unit 1000 (the simulation unit 153) determines whether to have a relation that “the assumed parts-purchase period H (variable)=the upper-limit value (D6b)”. If the H value becomes the upper-limit value (Y), the process ends (the prediction result D7 of the prediction-result data storage unit 114 is outputted). If the H value has not become the upper-limit value (N), “H+1” is substituted into “H” (as the variable) (the H value is incremented by 1 [month]) at the step S308, and the process returns to the step S305 to repeat the similar processes.

[Prediction Result]

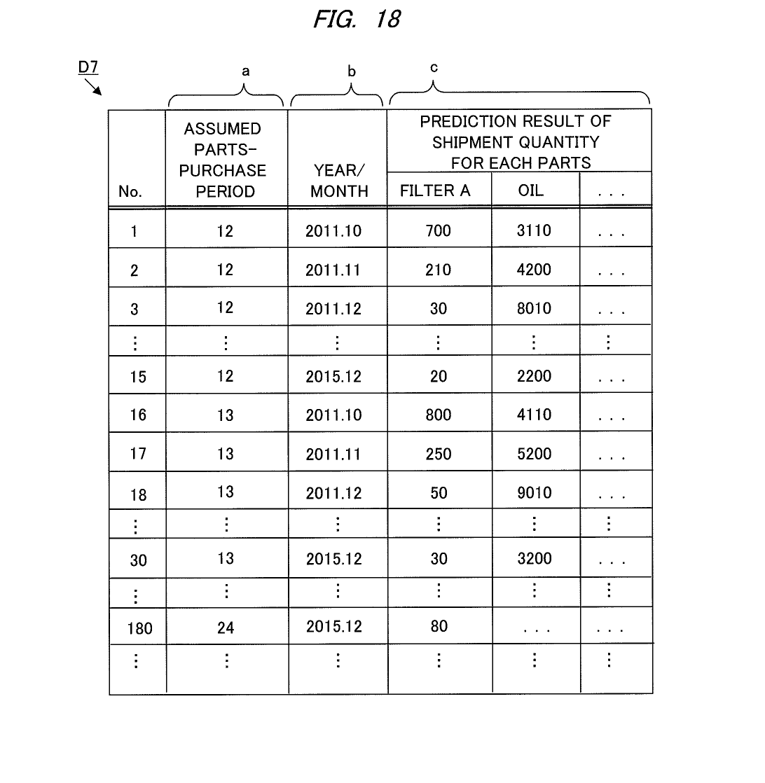

FIG. 18 is a table example of the (period H-dependent) prediction result data D7 of the future parts shipment quantity for each parts. As a data item, the “assumed parts-purchase period” denoted by “a” indicates the value of the above-describe H (variable) (whose unit is, for example, a month). Items denoted by “b” and “c” are similar to the items “a” and “b” of D0 in FIG. 6.

[Output Screen]

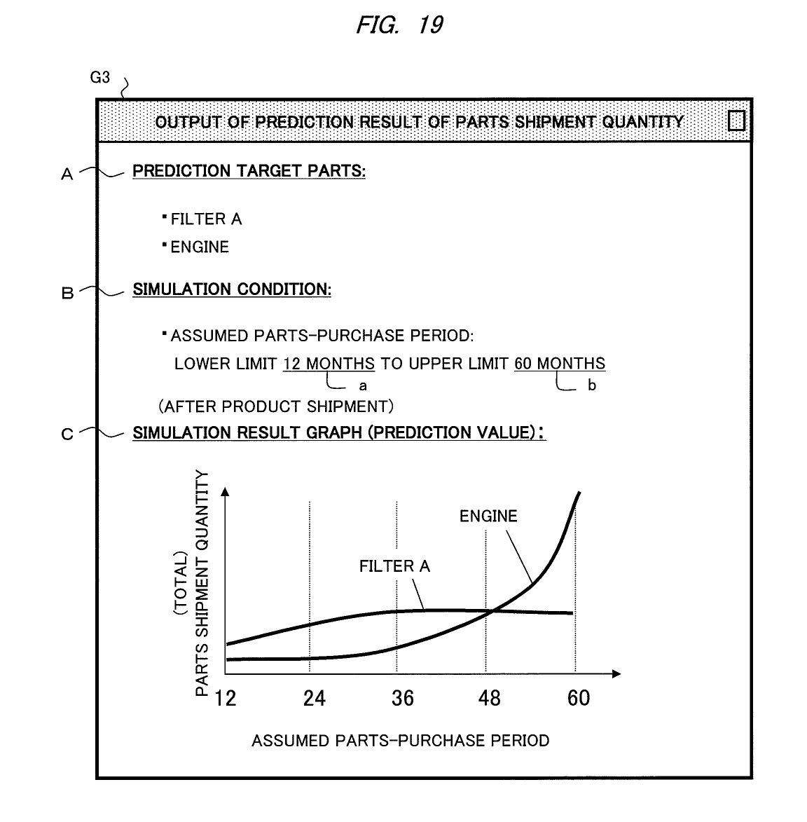

FIG. 19 illustrates an example of an output screen G3 used when the above-described simulation result (D7) is outputted via the user interface. As a display content example of the screen G3, (A) a prediction target parts, (B) a simulation condition (the value of the period H which is the prediction condition (D6)), and (C) a simulation result graph (a prediction result graph) are cited. As for the condition denoted by “B”, the value of the month as the lower-limit value of the period H and the value of the month as the upper-limit value thereof are displayed in respective sections (a and b). As for the graph denoted by “C”, the prediction value (total value) of the parts shipment quantity for each period H are displayed for each parts (such as the “filter A” and the “engine”) by, for example, a solid line. In this manner, the user can check the prediction value for each period H.

[Effect]

According to the third embodiment, particularly, the presence or absence of the decrease in the share of the manufacturer's genuine parts after the assumed parts-purchase period H and the influence on the parts shipment quantity from the variation in the H for each parts with a different parts failure rate can be quantitatively evaluated.

### Fourth Embodiment

Next, in a prediction system for the parts shipment quantity of a fourth embodiment, a structure obtained by adding a function to the third embodiment is described. A system 1D of the fourth embodiment includes a function (a parts-shipment cost maximization unit) of performing a process of optimizing the charge-free warranty period (P1 of FIG. 7) based on the simulation result (D7) of the parts shipment quantity of the third embodiment so that a “parts-shipment cost” is maximized.

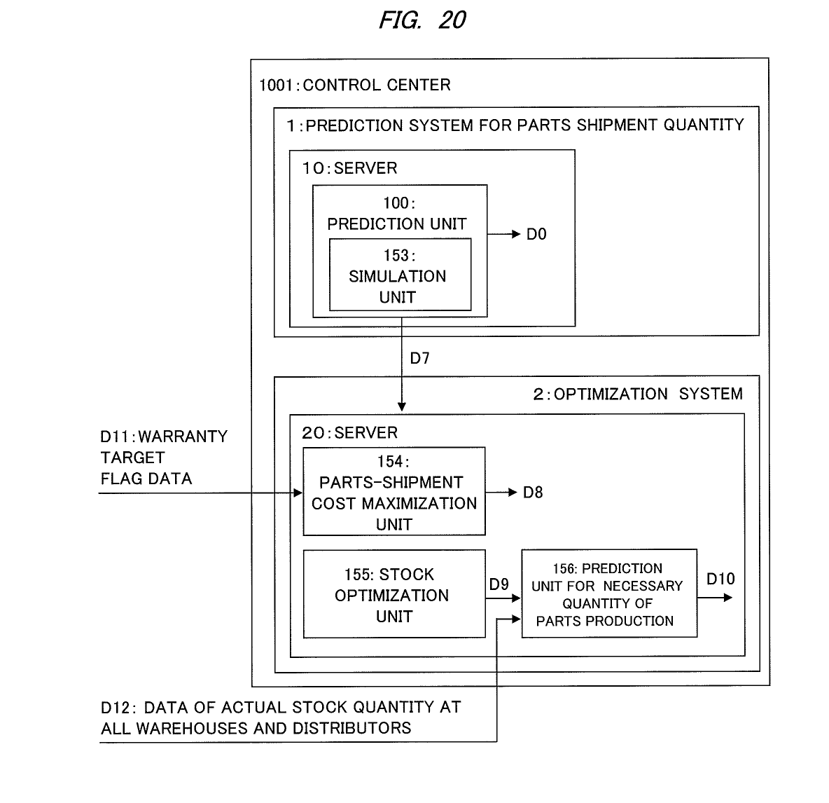

FIG. 20 illustrates a structure example of the prediction system 1 (the system 1D) for the parts shipment quantity of the fourth embodiment. Note that FIG. 20 also illustrates structure examples of fifth and sixth embodiments together with that of the fourth embodiment, and these embodiments can be variously combined with each other. FIG. 20 illustrates a case in which the present function (the parts-shipment cost maximization unit) is achieved as, for example, a processing unit (a software program process) included in the computer inside the control center 1001 of FIG. 1. An optimization system 2 inside the control center 1001 is configured of the computer of the server 20 or others, and the server 20 includes the parts-shipment cost maximization unit 154. The parts-shipment cost maximization unit 154 takes input (acquires) the prediction result data (D7) and warranty-target flag data D11 (warranty-target flag data D11 defined for each parts as the “charge-free parts” if the target is to be replaced by the manufacturer at no charge during the charge-free warranty period and as the “charged parts” if the target is out of the warranty) from the prediction system 1C for the parts shipment quantity of the third embodiment as illustrated in FIG. 16 or the DB 30, etc., the parts-shipment cost maximization unit calculates so as to maximize the parts-shipment cost of the charged parts, and the parts-shipment cost maximization unit stores and outputs output data D8 containing the calculation result (parts-shipment cost information) and the charge-free warranty period (an optimum charge-free warranty period) with the maximum parts-shipment cost. In the present calculation, such a state as “[parts-shipment cost]=[the charged parts shipment quantity]×[unit cost or benefit]−[the charge-free parts shipment quantity]×[unit cost or benefit]” is established.

[Warranty-Target Flag Data D11]

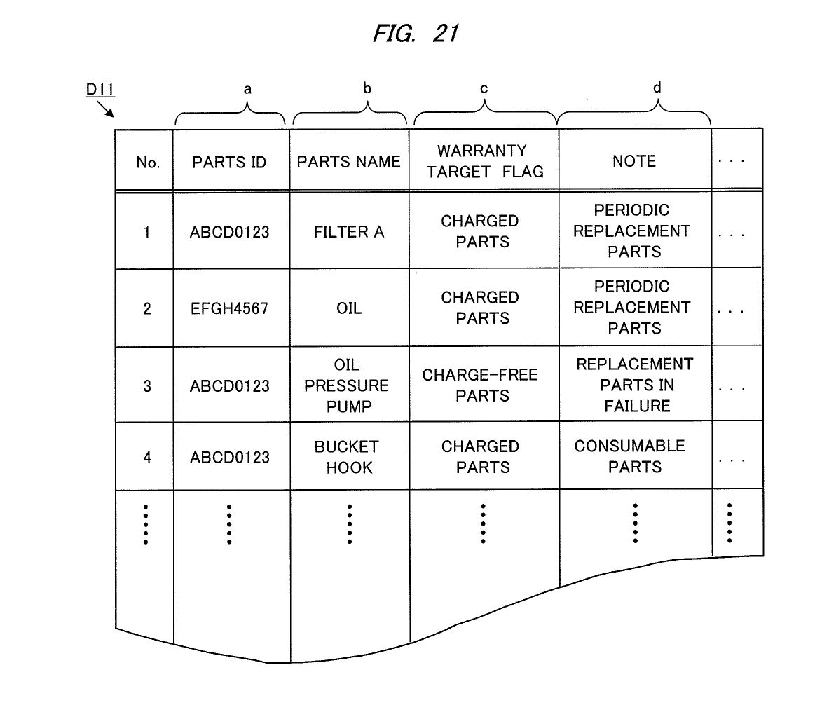

FIG. 21 illustrates a table example of the warranty-target flag data D11. The table has items of “No.”, “parts ID” (a), “parts name” (b), “warranty-target flag” (c), “note” (d), and others. The parts ID denoted by “a” and the parts name denoted by “b” are the same as those illustrated in FIG. 5 described above. The “warranty-target flag” denoted by “c” is written as the “charge-free parts” if the target is to be replaced by the manufacturer at no charge during the charge-free warranty period and as the “charged parts” if the target is out of the warranty. The “note” denoted by “d” is written as a parts type such as “periodic replacement parts”, “replacement parts at failure”, and “consumable parts” in accordance with a replacement method if needed. The example of FIG. 21 illustrates the case of the parts “filter A”, “oil”, “oil pressure pump”, and “bucket hook”.

[Output Screen]

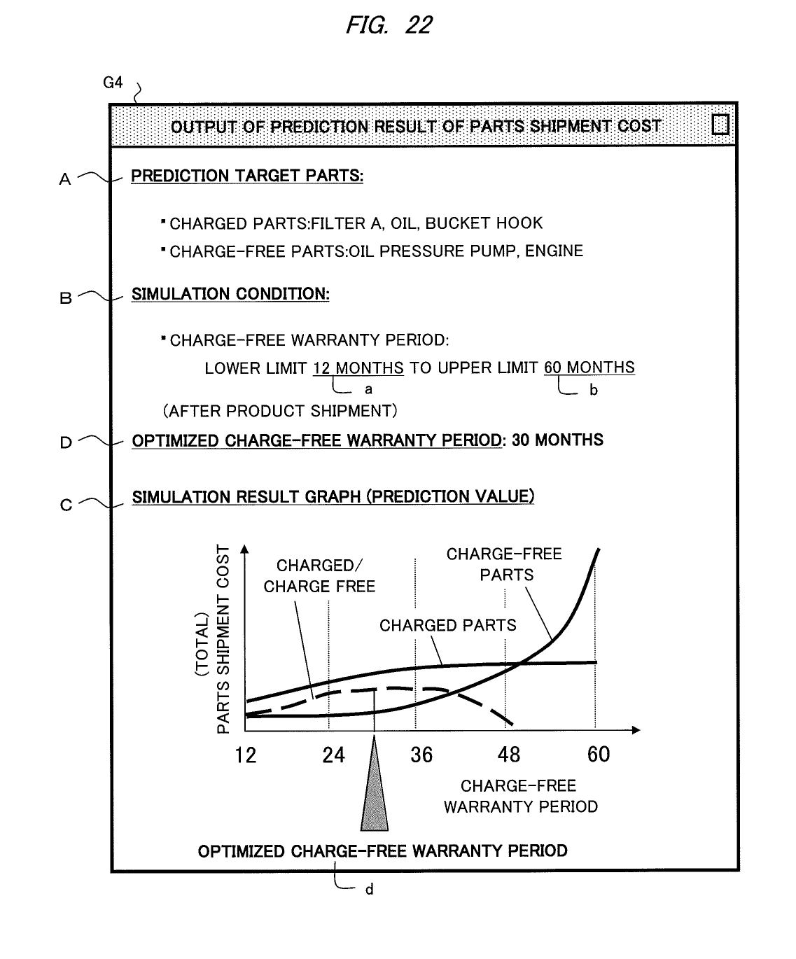

FIG. 22 illustrates an example of an output screen G4 used when the above-described simulation result (D7) is outputted via the user interface. As a display content examples of the screen G4, (A) a prediction target parts (classified in accordance with the definition of the warranty-target flag), (B) a simulation condition (the value of the assumed parts-purchase period H which is the prediction condition (D6)), (C) a simulation result graph (a prediction result graph), and (D) an optimum charge-free warranty period are cited. As for the condition denoted by “B”, a value of a month as the lower-limit value of the period H and a value of a month as the upper-limit value thereof are displayed in respective sections (a and b).

As for the graph denoted by “C”, the prediction value (total value) of the parts-shipment cost for each assumed parts-purchase period H is displayed for each definition as the “charged parts” or the “charge-free parts” of the warranty-target flag by, for example, a solid line. In addition, the [parts-shipment cost] which can be calculated by subtracting the parts-shipment cost of the charge-free parts from the parts-shipment cost of the charged parts is displayed by, for example, a broken line, and the optimum charge-free warranty period which is the charge-free warranty period in which the [parts-shipment cost] is maximized is illustrated on a horizontal axis (d). In this manner, the user can simultaneously check the prediction values of the parts-shipment costs for the charged and the charge-free parts for each period H and the optimum charge-free warranty period.

Here, as illustrated in the graph denoted by “C”, there is a general tendency that the charged parts formed of the periodic replacement parts such as the filter and the oil and the consumable parts such as the bucket hook are continuously sold from the beginning of the product shipment whereas the shipment of the replacement parts at failure such as the oil pressure pump and the engine increases after passing a certain degradation period from the product shipment. From the above description, it is found out to cause a trade-off between a state that the assumed parts-purchase period H (which is generally proportional to the charge-free warranty period) is shortened if the charge-free warranty period is too short, which results in decrease in the shipment quantity of the charged parts to decrease in the total parts-shipment cost and a state that the assumed parts-purchase period H is contrarily lengthened if the charge-free warranty period is too long, which results in increase in the charge-free warranted shipment of the replacement parts at failure most of which are relatively expensive to also decrease the total parts-shipment cost. Therefore, as described in the fourth embodiment (the parts-shipment cost maximization unit 154), it is important to optimize the charge-free warranty period so as to maximize the parts-shipment cost.

[Effect]

According to the fourth embodiment, particularly, the optimal charge-free warranty period can be predicted so as to maximize the parts-shipment cost even in the case of mixture of the charged parts and the charge-free parts.

### Fifth Embodiment

Next, in a prediction system 1 (1E) for the parts shipment quantity of a fifth embodiment, an example of a stock optimization system including a function capable of optimizing a stock (parts stock) in a supply chain (for example, FIG. 1) is described based on the above-described prediction system 1 for the parts shipment quantity (the first to fourth embodiments).

FIG. 20 illustrates a case in which the present function is achieved as a stock optimization unit 155 included in the server 20 inside the control center 1001 of FIG. 1 as similar to the fourth embodiment. The stock optimization unit 155 takes input of (acquires), for example, the prediction result data D7 for each warehouse or distributor from the prediction system 1C for the parts shipment quantity of the third embodiment or the DB 30, etc., the stock optimization unit calculates so as to optimize the stock for each warehouse or distributor, and the stock optimization unit stores and outputs information (D9) of the result.

As a calculus equation for optimizing the stock, for example, the following generally and widely used Equation (7) can be used.

[Equation 7]

[an optimal stock quantity of warehouse or distributor]=[a predicted value of the parts shipment quantity]×L+[safety coefficient]×[standard deviation of the predicted value of the parts shipment quantity from an actual value]×√L (9)

L: [lead time of the parts]

An optimization system 2 (the stock optimization unit 155) transmits stock instructions (A11 and A12) to each warehouse 1004 and each distributor 1005 by using, for example, information (A3 and A4) of stock states from each warehouse 1004 and each distributor 1005 of FIG. 1 and information (D9) of a calculation result for each warehouse 1004 and each distributor 1005 calculated by the Equation (7). In this manner, the parts stock quantity at each warehouse 1004 and each distributor 1005 is controlled to be optimized. The example of the above description (A3 and A4) is data D12 of an actual stock quantity at all warehouses and distributors in FIG. 20.

[Effect]

According to the fifth embodiment, particularly, the parts stock quantity at each warehouse and each distributor can be controlled to be optimized regardless of whether the share of the manufacturer's genuine parts after the assumed parts-purchase period H is decreased or not and even in the case of the mixture of the parts with different parts failure rates.

### Sixth Embodiment

Next, a prediction system 1 (1F) for a parts shipment quantity of a sixth embodiment includes a function (a prediction unit 156 for the necessary quantity of parts production) of predicting a total sum of stock shortages at all warehouses 1004 or all distributors 1005, that is, predicting the necessary quantity of parts production, by performing the stock optimization process of the fifth embodiment for each warehouse 1004 or each distributor 1005 of FIG. 1, and calculating a shortage of an actual stock quantity at each warehouse 1004 or each distributor 1005 from the obtained optimal stock quantity.

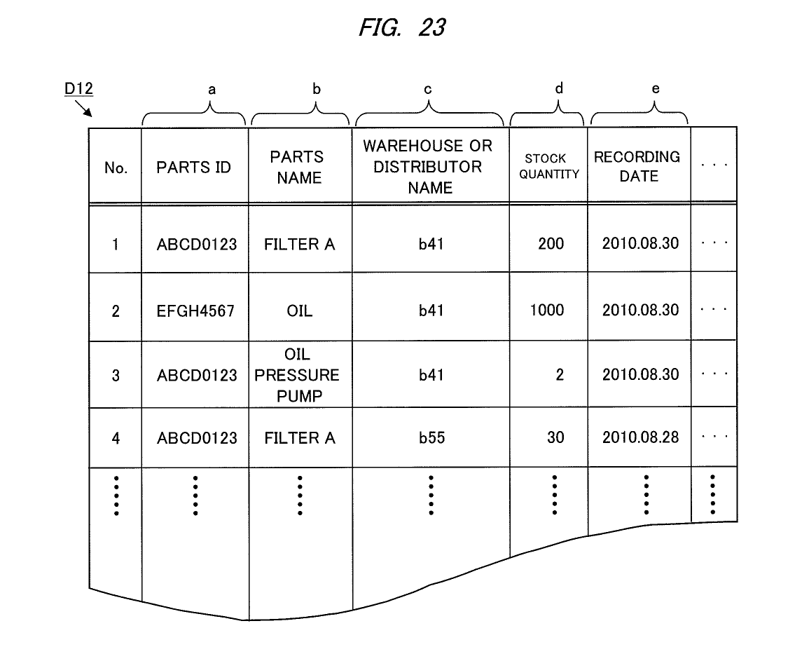

The present function (the prediction unit 156 for the necessary quantity of parts production) is achieved as, for example, a processing unit included in the server 20 of the optimization system 2 as illustrated in FIG. 20, the prediction unit takes input of the output (D9) from the stock optimization unit 155 of the fifth embodiment and the data D12 (for a specific example, see FIG. 23) of the actual stock quantities at all warehouses and distributors, the prediction unit calculates the necessary quantity D10 of the parts production, and the prediction unit stores and outputs the quantity D10. In the case of the sixth embodiment, note that there are a plurality of warehouses 1004 and distributors 1005 of FIG. 1 each having a computer to communicate with the control center 1001.

[Effect]

According to the sixth embodiment, particularly, the necessary quantity of the parts production in accordance with the shortage of the parts stock quantity at each warehouse and each distributor can be predicted regardless of whether the share of the manufacturer's genuine parts after the assumed parts-purchase period H is decreased or not and even in the case of the mixture of the parts with different parts failure rates.

[Effect and Others]

As described above, according to each of the embodiments, the parts shipment quantity varying in accordance with the assumed parts-purchase period H (such as the charge-free warranty period of the product) can be predicted, so that the prediction accuracy can be increased more than the conventional one. Also, the invention has an effect that, even when change of the charge-free warranty period or others is considered in parts business, it can be estimated to what extent the parts shipment quantity is affected by variation in the assumed parts-purchase period due to the change (the parts shipment quantity can be predicted).

In the foregoing, the invention made by the present inventors has been concretely described based on the embodiments. However, it is needless to say that the present invention is not limited to the foregoing embodiments and various modifications and alterations can be made within the scope of the present invention.

### INDUSTRIAL APPLICABILITY

The present invention can be used for a production management system, a SCM (supply chain management) system, and others.

### SYMBOL EXPLANATION

1 . . . a prediction system for a parts shipment quantity
2 . . . an optimization system
10 and 20 . . . a server
30 . . . a DB
100 . . . a prediction unit for a parts shipment quantity
101 . . . a data input processing unit
102 . . . a data output processing unit
111 . . . a customer-owned product data storage unit
112 . . . a parts-shipment data storage unit
113 . . . a prediction-condition storage unit
114 . . . a prediction-result-data storage unit
152 . . . an alert unit
153 . . . a simulation unit
154 . . . a parts-shipment cost maximization unit
155 . . . a stock optimization unit
156 . . . a prediction unit for the necessary quantity of parts production
200 . . . a calculation unit
201 . . . an input/output I/F unit
202 . . . a storage unit
205 . . . a bus
1001 . . . a control center
1002 . . . a parts factory
1003 . . . a supplier
1004 . . . a warehouse
1005 . . . a distributor
1006 . . . a job site
1007 . . . a service department
D0 . . . prediction result data
D1 . . . product data
D2 . . . parts shipment data
D3 . . . a prediction condition

1. A prediction system for a parts shipment quantity performing a process of predicting a parts shipment quantity of a product as a management target using information processing by a computer,
the computer including:
an input processing unit which performs a process of inputting product data, parts shipment data, and a prediction condition;
a storage unit which stores the product data, the parts shipment data, and the prediction condition;
a prediction unit to which the product data, the parts shipment data, and the prediction condition are inputted, and which performs a process of predicting a future shipment quantity for each parts to output prediction result data; and
an output processing unit which performs a process of storing or outputting the prediction result data,
the production data containing date information of actual shipment and removal for each product,
the parts shipment data containing date information and quantity information of the actual shipment for each parts,
the prediction condition containing information of an assumed parts-purchase period,
the assumed parts-purchase period having a period length during which a customer is assumed to purchase parts,
the assumed parts-purchase period being defined as an elapsed year/month with taking a product shipping date as a starting point or an operating time of the elapsed year/month with taking the product shipping date as the starting point in which only an operating time of the product is recorded, and
the prediction unit performing the process of predicting the future shipment quantity for each parts in accordance with the assumed parts-purchase period.

2. The prediction system for the parts shipment quantity according to claim 1,
wherein a charge-free warranty period of the product is provided as a factor for determining the assumed parts-purchase period, and
the charge-free warranty period of the product is a period during which execution of the maintenance in failure of the product is warranted by a manufacturer at no charge under a condition that the customer definitely uses the manufacturer's genuine parts as consumable parts or replacement parts for which periodic replacement is recommended.

3. The prediction system for the parts shipment quantity according to claim 1,
wherein one or more periods are provided as a factor for determining the assumed parts-purchase period, and
the prediction unit determines a value of the assumed parts-purchase period by a calculus equation of four arithmetic operations by using a value of each of the one or more periods serving as the factor and a coefficient value for each of the periods.

4. The prediction system for the parts shipment quantity according to claim 1,
wherein a value of the assumed parts-purchase period is inputted to the input processing unit via an input screen by a user operation, and
the input processing unit performs a process of setting the value as the prediction condition.

5. The prediction system for the parts shipment quantity according to claim 1,
wherein a value of a period including a charge-free warranty period of the product serving as a factor for determining the assumed parts-purchase period is inputted to the input processing unit via an input screen by a user operation, and
the input processing unit performs a process of determining a value of the assumed parts-purchase period and of setting the value as the prediction condition.

6. The prediction system for the parts shipment quantity according to claim 1,
wherein the output processing unit performs a process of displaying a prediction condition containing the assumed parts-purchase period and a graph based on the prediction result data on an output screen.

7. The prediction system for the parts shipment quantity according to claim 1,
wherein, in the prediction process by the prediction unit, the prediction unit performs
a first process of estimating an operating product quantity within an assumed parts-purchase period which is a product quantity during operation within the assumed parts-purchase period,
a second process of estimating a parts failure rate which is a failure rate of the parts, and
a third process of predicting the parts shipment quantity from a first model utilizing the operating product quantity within the assumed parts-purchase period estimated in the first process and the parts failure rate estimated in the second process.

8. The prediction system for the parts shipment quantity according to claim 1,
wherein, in the prediction process by the prediction unit, the prediction unit performs
a first process of estimating the operating product quantity within the assumed parts-purchase period and the quantity of all operating products which is the operating product quantity counted regardless of either a cumulative period from a product shipping date is within or without the assumed parts-purchase period,
a second process of estimating the parts failure rate,
a third process including: a process of predicting the parts shipment quantity from a first model utilizing the operating product quantity within the assumed parts-purchase period estimated in the first process and the parts failure rate estimated in the second process; and a process of predicting the parts shipment quantity from a second model utilizing the quantity of all operating products estimated in the first process and the parts failure rate estimated in the second process, and
a fourth process of outputting a prediction result from a model with a smaller prediction error of either a prediction error from the first model or a prediction error from the second model in the third process.

9. The prediction system for the parts shipment quantity according to claim 1,
wherein the prediction unit has an alert unit, and
parts shipment data for verification containing date information and quantity information of an actual shipment for each parts and a prediction condition containing a prediction-error upper-limit value for alerting are inputted to the alert unit, and
the alert unit performs a process of outputting an alert when a degree of the prediction error, which is an error between a prediction value and an actual value of the monthly shipment quantity for each parts, is larger than the prediction-error upper-limit value.

10. The prediction system for the parts shipment quantity according to claim 1,
wherein upper- and lower-limit values of an assumed parts-purchase period for simulation is inputted to the simulation unit as the prediction condition, and
the simulation unit performs a process of calculating a prediction value of the parts shipment quantity for each assumed parts-purchase period with taking the assumed parts-purchase period as a variable varying between the upper- and lower-limit values, and of outputting the prediction value as the prediction result data.

11. The prediction system for the parts shipment quantity according to claim 10,
wherein the computer has a parts-shipment cost maximization unit,
the prediction result data from the prediction unit and warranty-target flag data are inputted to the parts-shipment cost maximization unit,
the warranty-target flag data is data containing a warranty-target flag defined for each parts as a “charge-free parts” if the parts are a target to be replaced by a manufacturer at no charge during a charge-free warranty period or as a “charged parts” if the parts are out of the target, and
the parts-shipment cost maximization unit performs a process of selecting the charge-free warranty period during which a parts-shipment cost calculated by “[a parts-shipment cost]=[the charged parts shipment quantity]×[unit cost or benefit]−[the charge-free parts shipment quantity]×[unit cost or benefit]” is maximized and of outputting the result as an optimal charge-free warranty period.

12. The prediction system for the parts shipment quantity according to claim 1,
wherein the computer has a stock optimization unit,
the prediction result data from the prediction unit is inputted to the stock optimization unit, and
the stock optimization unit performs a process of calculating and outputting an optimal stock quantity, which is an optimal stock quantity of owned parts, for each warehouse or distributor.

13. The prediction system for the parts shipment quantity according to claim 12,
wherein the computer has a prediction unit for the necessary quantity of parts production, and
in all of a plurality of warehouses and distributors handling a plurality of types of parts as management targets, output result data of the optimal stock quantity from the stock optimization unit at each of the warehouses and the distributors and data of an actual stock quantity at each of the warehouses and the distributors are inputted to the prediction unit for the necessary quantity of parts production for each parts and for each of the warehouses and the distributors, and
the prediction unit for the necessary quantity of parts production performs a process of calculating a shortage of the actual stock quantity for the output result of the optimal stock quantity for each parts and for each of the warehouses and the distributors, of calculating a total sum of the shortages of the stock quantities at all of the warehouses and the distributors, each of the shortages being calculated for each of the warehouses and the distributors, and of predicting the total sum as a prediction for the necessary quantity of parts production at an own-company or other-company parts factory.

14. A program of making a computer execute a process of predicting a parts shipment quantity of a product as a management target,
the program achieving
an input processing unit which performs a process of inputting product data, parts shipment data, and a prediction condition,
a storage unit which stores the product data, the parts shipment data, and the prediction condition,
a prediction unit to which the product data, the parts shipment data, and the prediction condition are inputted, and which performs a process of predicting a future shipment quantity for each parts to output prediction result data, and
an output processing unit which performs a process of storing or outputting the prediction result data,
the production data containing date information of actual shipment and removal for each product,
the parts shipment data containing date information and quantity information of actual shipment for each parts,
the prediction condition containing information of an assumed parts-purchase period,
the assumed parts-purchase period having a period length during which a customer is assumed to purchase parts,
the assumed parts-purchase period being defined as an elapsed year/month with taking a product shipping date as a starting point or an operating time of the elapsed year/month with taking the product shipping date as the starting point in which only a machine operating time is recorded, and
the prediction unit performing the process of predicting the future shipment quantity for each parts in accordance with the assumed parts-purchase period.
